(19) United States
(12) Patent Application Publication
(10) Pub. No.: US 2026/0257185 A1
(43) Pub. Date: Sep. 3, 2026

(54) Reactor Systems for Gas Synthesis

(71) Applicant: 17, Inc., Mountain View, CA (US)

(72) Inventor: Garth Otway Ross Edwards, Mountain View, CA (US)

(21) Appl. No.: 19/489,492

(22) PCT Filed: Jun. 7, 2024
(86) PCT No.: PCT/US2024/032967

§ 371 Date: Dec. 2, 2025

Related U.S. Application Data
(63) Continuation-in-part of application No. 18/587,816, filed on Feb. 26, 2024.
(60) Provisional application No. 63/506,815, filed on Jun. 7, 2023.

(51) Int. Cl. B01J 8/04; C01C 1/04

(52) U.S. Cl. CPC B01J 8/0473; B01J 8/0496; C01C 1/0452; B01J 2208/00097; B01J 2208/00194

(57) ABSTRACT

Chemical reactor systems for gas synthesis with batch, pseudo-batch or dynamic reactor of one or more individual catalytic reactors for gas synthesis, one or more fluid control mechanisms of shared pipe and manifolds for delivery of reactants to and collection of reaction product from the chemical reactor system, and a control system capable of opening the one or more fluid control mechanisms to control entry of reactants to and exit of reaction products from the chemical reactor system are provided. Methods for use of these systems in gas synthesis, and in particular, ammonia synthesis, and to retrofit ammonia synthesis plants are also provided. The disclosed chemical reactor systems are particularly suitable for use in ammonia (NH3) synthesis and enable the well established gas catalytic chemistry as used in most Haber-Bosch processes to be adapted to variable or intermittent renewable energy power sources.

This patent application claims the benefit of priority from U.S. patent application Ser. No. 18/587,816, filed Feb. 26, 2024 and U.S. Provisional Application Ser. No. 63/506,815, filed Jun. 7, 2023, teachings of each of which are herein incorporated by reference in their entireties.

### BACKGROUND

The discovery in the early 1900s by German chemists Fritz Haber and Carl Bosch of a process to synthetically produce ammonia is perhaps one of the most important in recent history. Their invention reacted nitrogen and hydrogen at high temperature and pressure in the presence of a catalyst following this exothermic, reversible reaction:

$${N}_{2} + 3 {H}_{2} ⇋ 2 N {H}_{3} + ∼ 92 kJ$$

The first commercial production was in 1913 at a BASF plant in Ludwigshafen with a capacity of ~25 tons of ammonia per day (see BASF History at basf with the extension.com/ca/en/who-we-are/history/1902-1924.html of the world wide web). Ammonia plant sizes and global production capacity has since grown significantly to reach ~200 billion tonnes annually worldwide with modern refineries capable of producing over 3000 tonnes of anhydrous ammonia per day. It is estimated that 50% of the food consumed by humans is grown using fertilizers based on synthetically produced ammonia.

Currently over 95% of synthetic ammonia production uses fossil fuel feedstock as a source for the hydrogen (H₂) necessary for the reaction; “gray ammonia” uses natural gas feedstock and “brown ammonia” uses fuel oil or coal feedstock. The consumption of fossil fuels for gray and brown ammonia production is currently responsible for ~2% of global greenhouse gas emissions.

“Green ammonia” (using renewable energy to create hydrogen from water) shows significant potential as a high-density, carbon-free energy carrier that can be used to store and transport renewable energy. In addition to storing and transporting renewable energy, the world needs to move existing ammonia demand from gray/brown to green to lower greenhouse gas emissions.

While the process for green ammonia production is well known, the intermittency of the most popular renewable energy power sources, such as wind turbines and photovoltaic (PV) solar, creates problems for large scale ammonia production. For economics and efficiency, renewable energy power plants prefer to sell power directly to customers as it is being produced but often suffer from “curtailment” where there is unwanted, excess energy at times of low consumer demand (e.g. during peak solar PV output in the middle of the day). This means that excess energy for ammonia production from non-dedicated renewable power sources often has an even narrower window of availability.

In contrast, modern ammonia refineries operate continually 24 hours a day, 365 days per year to maximize output, revenue and efficiency; they are not suited to being powered by intermittent renewable energy sources which have capacity factors under 40%. Matching renewable energy power technology to classical synthetic ammonia production techniques would require very large energy storage (batteries), large hydrogen storage or likely a combination of the two for over half of any production output.

Regardless of intermittency and timing, most industrial scale ammonia refineries, if converted to green ammonia, would require energy inputs greater than even the largest renewable power plants in the world. Currently the majority of solar power plant sizes in the United States are less than 5 MW peak power output (See Ammonia as a Renewable Energy Transportation Media at pubs with the extension .acs.org/doi/10.1021/acssuschemeng.7b02219 of the world wide web). Green ammonia is expected to require 10-12 MWh/ton (see Bhadla Solar Park at en with the extension .wikipedia.org/wiki/Bhadla_Solar_Park of the world wide web) meaning that even the first, small 25 ton/day BASF ammonia plant would have required 12 MW average power and >40 MW peak solar plant output (based on a 25% capacity factor or 6 hours/day solar output). A 3000 ton/day ammonia plant would require an estimated 5.5 GW of rated power, more than twice the rated power of the largest solar plant in the world (see Bhadla Solar Park at en with the extension .wikipedia.org/wiki/Bhadla_Solar_Park of the world wide web) and nearly four times the rated power of the largest wind farm in the world (see Hornsea Project Two at en with the extension .wikipedia.org/wiki/Hornsea_Wind_Farm#Hornsea_Project_Two of the world wide web) as of early 2023.

For industrial ammonia production to be adapted to existing renewable energy sources, in terms of both size and intermittency, ammonia synthesis reactors (and their associated systems) need to be significantly redesigned for scale, turndown capabilities and non-continuous operation.

Ammonia synthesis reactors have historically been designed as steady-state, adiabatic, plug flow, packed bed reactors filled with solid, 1-10 mm diameter catalyst beads. Catalyst materials are typically magnetite (Fe₃O₄), wustite (Fe_{1-X}O) or ruthenium (Ru) based.

The stoichiometric gas ratios and exothermic reaction mean that ammonia production is thermodynamically favored at higher pressure and lower temperature, in accordance with Le Chatelier's principle (see Le Chatelier's Principle at en with the extension .wikipedia.org/wiki/Le_Chatelier%27s_principle of the world wide web), however lower reaction temperatures create challenges for nitrogen activation and results in a slower rate of reaction. Industrial Haber-Bosch synthesis is typically performed using a compromise of moderate to high pressures (150-400 bar) favoring ammonia conversion with higher temperatures (400-600° C.) to increase the reaction rate at the expense of conversion.

The higher operating temperature of industrial Haber-Bosch reactors means a <100% equilibrium product conversion limit; this combined with catalyst performance limitations typically result in less than 30% of the reactants being converted to ammonia per pass through the reactor with 3 or more passes required to fully convert the reactants. This results in higher compression requirements, larger equipment sizing and lower overall energy efficiency.

The use of plug flow reactors with either exothermic or endothermic reactions creates design and operation complexities; for exothermic reactions good temperature control is required in order to avoid reactor hot spots and catalyst sintering. In a single bed plug flow reactor the conversion of reactants progresses towards equilibrium as each “plug” of reactants moves through the axial length of the reactor; for an exothermic reaction the temperature profile increases along the length of the reactor. Without a reliable mechanism for heat removal the reactant/product gasses, reactor and catalyst will keep increasing in temperature along the catalyst bed path until either the catalyst sintering or design temperature is reached (whichever comes first). The catalyst located towards the exit of the reactor bed is constantly at higher temperature than the catalyst near the reactant entry; temperature limitations effectively limit the catalyst bed length and hence reactor residence time. Typically an ammonia refinery will have a single reactor pressure vessel housing multiple catalyst beds with cooler “quench gas” added between beds for temperature control and to increase reactant concentration as ammonia is produced. An example of this is shown in FIG. 1A.

FIG. 1A illustrates a generic multi-bed single vessel plug flow reactor using quench cooling commonly used in industrial ammonia production. In this system a pressure vessel (1) houses multiple axial flow catalyst beds (2) sized for a target residence time or Gas Hourly Space Volume (GHSV) at the design flow rate. A mixture of partially pre-heated hydrogen and nitrogen reactant feed gas enters the reactor (3) with some variations using cold feed gas to cool the catalyst bed walls on entry (4). Reactant gas is directed to an internal heat exchanger (5) to heat the reactants (simultaneously cooling the hot product gas leaving the last catalyst bed) before being passed via internal piping (6) to the first of the catalyst beds (2). Ammonia is produced within the catalyst beds via the exothermic reaction of the reactant feed gasses; the heat released increases the temperature within the reactor, slowing the forward progression of the reaction and limiting the reaction equilibrium product concentration. To keep the catalyst below the sintering temperature, dilute the product concentration and maintain moderate reaction temperatures for better conversion, quench gas (7) made up of cooler reactant gasses is added directly between the catalyst beds. After the gasses have passed through the final catalyst bed they are directed to the internal heat exchanger (5) before exiting the reactor (8).

FIG. 1B illustrates a generic three bed adiabatic quench reactor system similar to the one shown in FIG. 1A but using dedicated reactor vessels in series for each catalyst bed; splitting a single reactor into multiple vessels may be required due to space or height constraints. In this system each reactor pressure vessel (21, 26, 29) is equipped with a catalyst bed (22) and a mixture of pre-heated hydrogen and nitrogen feed gasses enter the first reactor (23). The reactor catalyst beds are sized to give the overall system a target residence time or GHSV at the design flow rate. Detailed depictions of necessary reactor vessel internals, such as gas distributors or catalyst baskets are not shown. As the reactants flow through each catalyst bed and ammonia is produced in the exothermic reaction, heat is released which both slows the forward progression of the reaction and increases the temperature of the reactor vessel, catalyst and gasses. The hot gasses are removed from the reactor (24, 27) and diluted with colder hydrogen/nitrogen reactants known as “quench gas” (25, 28) at the inlet of reactor 26 and reactor 29 to prevent overheating of the catalyst and further dilute the product gasses (to increase the ammonia output). The output of the multi-bed, multi-reactor system (30) is a mix of unreacted hydrogen and nitrogen gasses, with gaseous ammonia product. An overall conversion efficiency of ~30% would be typical for this arrangement. Product gasses (30) are typically cooled to separate the ammonia product from unreacted feed gasses which are then recycled back to the first reactor (21).

An important consideration when designing any vessel is the ratio of the reactor length (L) to the diameter (D) which has an effect on the distribution of reactants across the catalyst bed as well as the pressure drop through the reactor. For a plug flow reactor with a given overall reactor volume, a higher L/D ratio (i.e. a reactor that is narrower but longer) will generally have a better reactant distribution across the catalyst bed with less channeling, lower risk of catalyst “hot spots” due to localized reactions, less need for complicated inlet distribution designs, increased catalyst efficiency and better performance during turndown. However higher L/D ratios result in increased gas velocity through the catalyst bed due to the smaller diameter and this combined with the increased bed length incurs a larger pressure drop along the reactor, resulting in higher compression energy costs.

To overcome fluid distribution, catalyst hotspots and pressure drop issues, modern reactor designs have added complexities such as radial flow beds (FIG. 1C), axial/radial flow combinations, external heat exchangers and even multi-tubular reactor arrangements; these also help smooth and control reactor temperature profiles. In spite of modern refinements, turndown is typically limited to ~50% of the reactor design flow due to channeling, inefficient catalyst use and the resulting undesirable temperature gradients, hot spots and catalyst sintering that may occur.

FIG. 1C illustrates a generic multi-bed radial flow reactor with integrated feed gas heat exchanger, commonly used in existing commercial ammonia synthesis processes. In this system a pressure vessel (41) houses multiple radial flow catalyst beds (42, 43, 44) sized for a target residence time or GHSV at the design flow rate. A mixture of partially pre-heated hydrogen and nitrogen reactant feed gas enters the reactor (45) with some variations using cold feed gas to cool the catalyst bed walls on entry (46). Reactant gas is directed to an internal heat exchanger (47) to heat the reactants (simultaneously cooling the hot product gas leaving the last catalyst bed) before being passed via internal piping (48) to the first of the catalyst beds (42). Ammonia is produced within the catalyst beds via the exothermic reaction of the reactant feed gasses; the heat released increases the temperature within the reactor, slowing the forward progression of the reaction and limiting the reaction equilibrium product concentration. To keep the catalyst below the sintering temperature, dilute the product concentration and maintain moderate reaction temperatures for better conversion, quench gas (49) made up of cooler reactant gasses is added between the catalyst beds. After the gasses have passed through the final catalyst bed they are directed to the internal heat exchanger (47) before exiting the reactor (50).

Catalyst lifetime, while typically 5-10 years, is shorter than the reactor life and will need changing. More complex arrangements such as multi-bed reactors with complex internals create access and design difficulties for catalyst removal and loading. One recent study showed that catalyst replacement in a typical multi-bed ammonia synthesis reactor took over 450 hours due in part to the physical complexity of the reactor (see Catalyst Replacement Time; ISSN 0149-3701; and ammoniaknowhow with the extension .com/optimizing-the-installation-and-operation-of-a-new-3-bed-ammonia-synthesis-converter-basket/of the world wide web).

There has been some effort to design isothermal (constant temperature) instead of adiabatic reactors though even for a moderately exothermic reaction such as ammonia synthesis this involves significant internal and external mechanical complexities due to the need to remove heat evenly across the catalyst beds.

The reason that the majority of state-of-the-art ammonia synthesis reactors are still based on adiabatic plug flow designs is primarily because they are suited to the high, constant flow rates required by modern, custom built ammonia refineries that are designed for scaled ammonia production. The advantages of the state-of-the-art designs include a high production rate per weight of catalyst, increased contact between reactant and catalyst surface at the design conditions and lower reactor metal weight to catalyst ratio (a proxy for reactor fabrication cost).

In parallel, the current state-of-the-art is specifically designed and able to operate in steady state control mode which significantly simplifies process control mechanisms. It should be remembered that the trajectory of current ammonia synthesis reactors was started back in 1913, before the current automated process control mechanisms were available; reactors needed to be designed for high flow rates with as little external (and often manual) control intervention as possible. Without the use of plug flow reactors operating in steady state it would not have been possible for the industry to have reached the impressively high level production rates it achieved, even before the advent of computerized and automated process control systems.

The need for steady state operation has been reinforced by two additional factors that influence the current state-of-the-art. As mentioned previously, over 95% of ammonia production (and hence synthesis reactors) are installed in plants that source their hydrogen feedstock from fossil fuels. The plant upstream of the ammonia synthesis reactor is either a steam-methane-reforming (SMR) system for natural gas feedstock or a coal-gasification system for coal feedstock. Both SMR and coal gasification systems are highly complicated to design, build and operate with limited turndown capabilities; all efforts are made to ensure a steady state flow through the downstream Haber-Bosch systems to minimize excursions in operating conditions and product specifications in the complex upstream systems. In parallel, the use of centrifugal compressors for feed gas compression is popular on high throughput facilities due to their improved performance and economics at high flow rates; high rate gas compression systems work best at steady state operation and suffer from limited turndown capabilities which reinforces the current reactor design focus of steady state operation.

Reactors designed for green ammonia production are freed from the upstream SMR or coal gasification systems constraints of steady state and from the high flow rate compression gas systems needed for economics at larger scale; in parallel engineers are now able to take advantage of highly capable automated computer control systems. Modern ammonia synthesis reactor design is therefore able to take advantage of opportunities for varied throughput, higher turndown ratios and systems that rely on highly complex process control.

In summary, current state-of-the-art reactors are wholly unsuited to the relatively low scale of green ammonia production using intermittent power provided by most clean energy sources (with perhaps the exception of geothermal). Current state-of-the-art reactors are designed for custom build, high throughput, continuous, steady-state operation; green ammonia reactors must be designed for small scale (low throughput), variable output, high turndown, rapid startup and high efficiency, while still remaining effective at high temperatures and pressures.

There is a need for improved chemical reactor systems for gas synthesis, and in particular systems capable of being coupled to intermittent or variable energy production technologies.

### SUMMARY OF THE INVENTION

An aspect of this disclosure relates to chemical reactor systems for gas synthesis.

Systems of this disclosure comprise a batch, pseudo-batch or dynamic reactor of one or more individual catalytic reactors for gas synthesis. The use of highly simplified or modular reactors described by the present invention, particularly when constructed from standardized parts as described herein, makes the overall system cost competitive.

In one nonlimiting embodiment, the chemical reactor system comprises a batch, pseudo-batch or dynamic temperature swing gas synthesis reactor system of one or more individual catalytic reactors for gas synthesis.

In an alternative nonlimiting embodiment, the chemical reactor system comprises a multi-vessel batch, pseudo-batch or dynamic reactor of connected individual catalytic reactors for gas synthesis.

The chemical reactor systems further comprise one or more fluid control mechanisms connecting the individual catalytic reactors of one or more multi-vessel batch or pseudo-batch reactors and a control system capable of opening the one or more fluid control mechanisms to control entry of reactants to and exit of reaction products from the system.

In one nonlimiting embodiment, the control system is capable of controlling reactor entry and exit mechanisms in the system to facilitate fluid flow in series, parallel or a combination thereof through the individual catalytic reactors such that fluid flow through the chemical reactor system is close to continuous, while fluid in each individual reactor is stationary or close to stationary for a portion of its residence time.

The control system may be automated and/or capable of operating individual or groups of catalytic reactors in batch operating mode, or continuous, steady state or plug flow operating mode.

Individual catalytic reactors used in the chemical reactor systems may be equipped with internal or external heat transfer systems to modify the temperature of the reactor as the reaction progresses and/or one or more sensors, detectors or controllers that passes information to the control system so that the chemical reactor system operates in a manner that allows continuous inlet flow of reactants and outlet flow of reaction products through the chemical reactor system.

Individual catalytic reactors used in the chemical reactor systems of this disclosure may be designed as pipe-in-pipe heat exchangers.

Control systems used in the chemical reactor systems of this disclosure may be computerized and connected to a remote or cloud based controller and/or may use algorithms, predictive control, artificial intelligence or machine learning to optimize performance of the individual or group of catalytic reactors vessels and the chemical reactor system.

In one nonlimiting embodiment, the chemical reactor system is used for ammonia synthesis.

Another aspect of this disclosure relates to energy waste reduction systems comprising a chemical reactor system as disclosed herein coupled to a variable or intermittent energy production technology. In one nonlimiting embodiment, coupling of a chemical reactor system of the present invention to a variable or intermittent energy production technology enables a Power-to-X (also P2X or P2Y) system.

Another aspect of this disclosure relates to a method for producing a gas by coupling an intermittent energy production technology to a chemical reactor system as disclosed herein.

Another aspect of this disclosure relates to a method for producing a gas via the steps of: supplying synthesis feed gas to a chemical reactor system as disclosed herein; opening the one or more fluid control mechanisms of an individual catalytic reactor or group of reactors to enable sufficient synthesis feed gas to pass into each reactor such that it is filled with the feed gas; closing the one or more fluid control mechanisms once filled with feed gas to stop or sufficiently slow flow of gas in contact with the catalyst to allow the reaction to take place; timing, predicting and/or monitoring temperature, pressure and/or other measurable states within each closed or partially closed reactor to determine reaction progression; and expelling a reaction product once the reaction has reached the desired reaction progress.

Another aspect of this disclosure relates to a method for retrofitting an ammonia plant having a synthesis loop wherein fresh ammonia synthesis gas containing hydrogen and nitrogen is combined with any recycle streams to form a combined ammonia synthesis gas and the combined ammonia synthesis gas is reacted over a catalyst to form a converted ammonia product gas. The retrofitting method involves the steps of: replacing an existing ammonia synthesis reactor or reactors with a chemical reactor system as disclosed; installing feed gas heat exchangers capable of heating a synthesis gas to a targeted and controlled temperature as required for reactor batch operation upstream of the chemical reactor system; installing heat exchangers and a vapor-liquid separator for condensing and recovering ammonia from the reactor effluent stream and forming an ammonia-lean stream; and installing a pressure control system to enable operating pressure of the chemical reactor system to be controlled and manipulated.

Another aspect of this disclosure relates to a method for producing ammonia from synthesis gas containing hydrogen and nitrogen combined with any recycle streams. In this production method, synthesis feed gas is supplied to a system comprising one or more catalyst filled pressure vessel reactors, each catalyst filled pressure vessel reactor being connected to one or more manifolds at the inlet and one or more manifolds at the outlet of the system, each catalyst filled pressure vessel reactor being equipped with an independently operated mechanism to control, direct and stop the flow of fluids to or from the individual vessel and catalyst bed via said inlet and outlet manifolds. The control mechanism of a selected catalyst filled pressure vessel reactor or group of catalyst filled pressure vessel reactors is then opened to enable sufficient synthesis feed gas to pass into each catalyst filled pressure vessel reactor from its inlet manifold such that it is filled with the feed gas and pressurized to a selected operating pressure. The control mechanisms at each end of the selected catalyst filled pressure vessel reactor or group of reactors is then closed once filled with feed gas to stop or sufficiently slow the flow of gas in contact with the catalyst to allow the reaction to take place. Temperature, pressure and/or other measurable states are then timed, predicted and/or monitored within each closed or partially closed catalyst filled pressure vessel reactor to determine the reaction progression. Once the reaction has reached a desired state, conversion or equilibrium conversion, the catalyst filled pressure vessel reactor or reactors are then allowed to cool below the ammonia product critical point or dew point temperature and, once sufficiently cooled, liquid ammonia product that collects at the lower portion of the catalyst filled pressure vessel reactor or reactors is expelled without allowing the majority of unreacted gasses to escape the catalyst filled pressure vessel reactor or reactors. The filling process is then repeated by adding new synthesis feed gas to any unreacted gasses remaining in the catalyst filled pressure vessel reactor or reactors.

In this production method, one or more of the catalyst filled reactor vessels can be used to store reactants at high pressure prior to introduction of a second reactant to start the ammonia production process in a controlled manner.

In this production method, the hydrogen and/or nitrogen can stored in the one or more catalyst filled pressure vessel reactors at sufficiently high pressure during periods when power is available so that they can be transferred to a portion of the one or more catalyst filled pressure vessel reactors to produce ammonia during periods when power is not available such as, but not limited to, overnight or when there is no wind or sun.

In this production method, the one or more catalyst filled pressure vessel reactors can be filled with feed gas in sequence to allow batch or close to batch residence time in each reactor while having a continuous or close to continuous flow of feed gas through the entire system of reactor vessels.

In this production process, the one or more catalyst filled pressure vessel reactors may be equipped with sensors, detectors or controllers that pass information to a control system or systems such that the system of reactors, mechanisms, sensors and control system is able to operate in a manner that allows continuous inlet flow of feed gas and outlet flow of products through the overall system of reactors.

In this production process, the one or more catalyst filled pressure vessel reactors may be equipped with a control system capable of manipulating the reactors and their fluid control mechanisms such that they are filled with synthesis gas in sequence to allow batch or close to batch residence time in each reactor while having a continuous or close to continuous flow of feed gas through the entire system of reactor vessels.

In this production process, the one or more catalyst filled pressure vessel reactors may be equipped with a control system capable controlling the synthesis feed gas temperature.

In this production process, the one or more catalyst filled pressure vessel reactors may be equipped with a control system capable controlling the reactor system operating pressure.

In this production process, the one or more catalyst filled pressure vessel reactors may be equipped with an internal or external heat transfer system to modify the temperature of the reactor as the reaction progresses.

In this production process, the one or more of the catalyst filled pressure vessel reactors may be designed as pipe-in-pipe heat exchangers.

In some embodiments of the present invention, the ratio of the reactants entering the vessel are modified to control the reaction progression and heat released through the reactor vessel wall. In one nonlimiting embodiment a reactor is first filled to a desired pressure with hot, compressed hydrogen only then nitrogen is added sufficiently gradually such that the heat generated by the exothermic reaction matches the heat released to the atmosphere through the reactor wall. In this nonlimiting embodiment the reaction temperature is held constant by controlling the amount of ammonia produced and thus exothermic reaction heat released by controlling the entry of nitrogen to match the heat released from the reactor to the atmosphere. An additional advantage of this nonlimiting embodiment of the present invention is the use of Le Chatelier's principle whereby a high (or excess) concentration of reactants will push the reaction towards the product side, resulting in a higher equilibrium conversion for a given operating temperature and pressure. The ability to remove liquid product without the unreacted feed gas allows the use of stoichiometrically incorrect or non-stoichiometric reactant ratios without the penalty of increased compression due to high recycle rates.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Nonlimiting and non-exhaustive descriptions are described with reference to the following drawings. The components in the figures are not necessarily to scale, emphasis instead being placed upon illustrating principles. Some embodiments of the present invention are illustrated as an example and are not limited by the figures of the accompanying drawings, in which like references may indicate similar elements:

FIG. 1A depicts a prior art standard multi-bed adiabatic quench reactor with integrated feed gas heat exchanger, commonly used in ammonia synthesis processes.

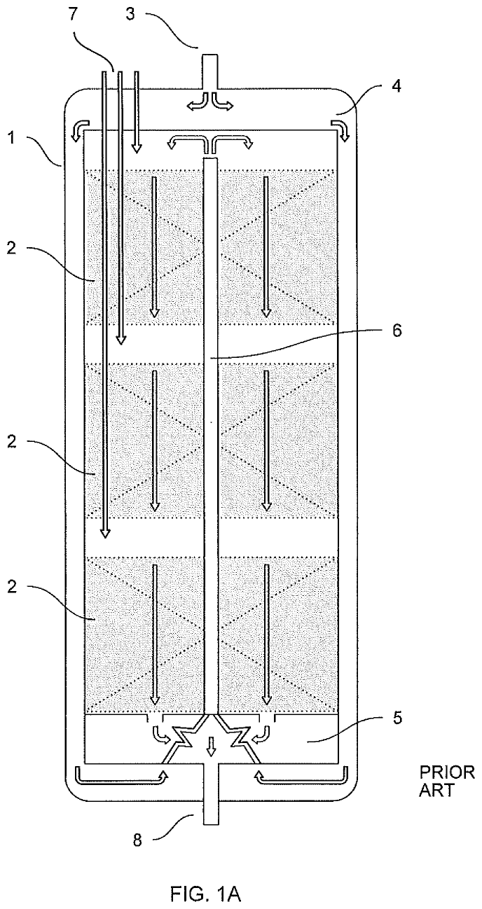

FIG. 1B depicts a prior art standard multi-bed radial flow reactor with integrated feed gas heat exchanger, commonly used in ammonia synthesis processes.

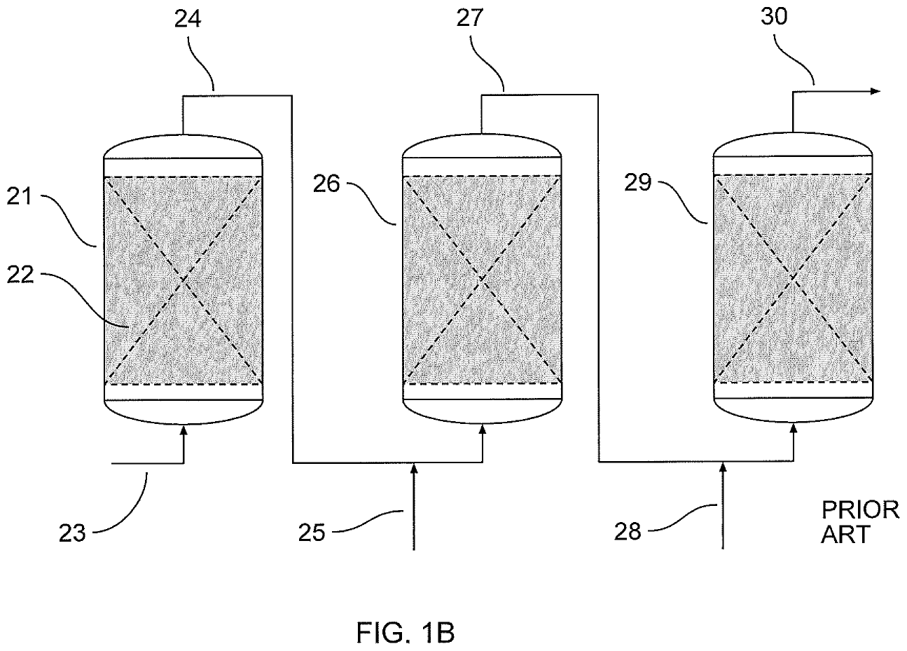

FIG. 1C depicts a prior art three bed adiabatic quench reactor system similar to the one shown in FIG. 1A but using dedicated reactor vessels in series for each catalyst bed, commonly used in ammonia synthesis processes.

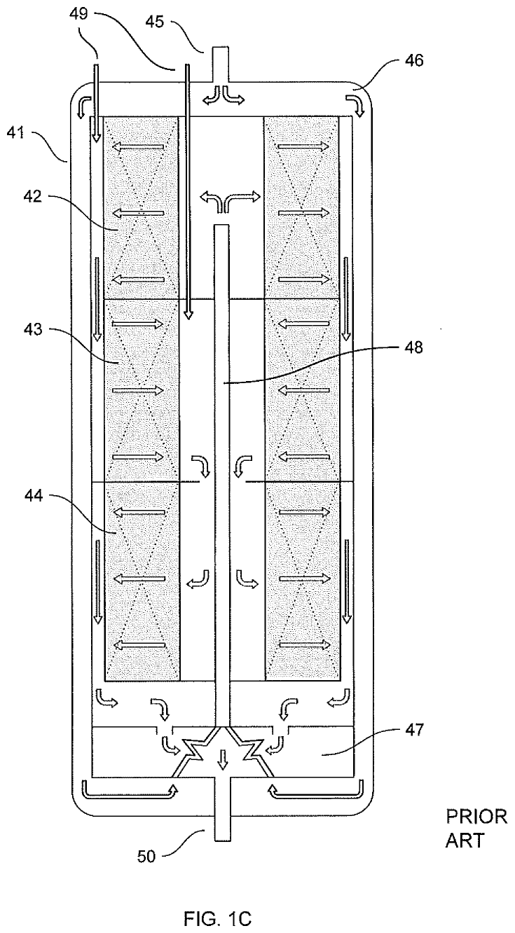

FIG. 2 illustrates a chemical reactor system for gas synthesis as a representation of a nonlimiting embodiment of the present invention: a multi-vessel temperature swing reactor system with shared entry for reactants and exit of reaction products.

FIG. 3 illustrates a chemical reactor system for gas synthesis as a representation of a nonlimiting embodiment of the present invention: a multi-vessel temperature swing reactor system with shared entry for reactants and exit of reaction products using multiport valves.

FIG. 4 illustrates a chemical reactor system for gas synthesis as a representation of a nonlimiting embodiment of the present invention: a multi-vessel temperature swing reactor system with shared entry for reactants and exit of reaction products with multiple inlet manifolds.

FIG. 5 illustrates a cross sectional view of one nonlimiting embodiment of an individual reactor pressure vessel used in a temperature swing reactor system of the present invention.

FIG. 6 illustrates a cross sectional view of a nonlimiting embodiment of an individual reactor pressure vessel used in a temperature swing reactor system of the present invention with an active cooling system included.

FIG. 7 illustrates a cross sectional view of a nonlimiting embodiment of an individual reactor used in a temperature swing reactor system of the present invention where a typical pressurized gas storage tank is filled or partially filled with catalyst for use as a reactor pressure vessel and shown in FIG. 2, FIG. 3 and FIG. 4.

FIG. 8 is a process schematic of a nonlimiting example of an ammonia production system that illustrates how the temperature swing reactor system of the present invention interacts with other parts of the production system.

FIG. 9 is a process schematic of one nonlimiting embodiment of a control system for the temperature swing reactor system of the present invention.

FIG. 10 is a process schematic of one nonlimiting embodiment of the temperature swing reactor system of the present invention for ammonia production system during periods of low power availability (e.g. overnight ammonia production for solar powered systems).

FIG. 11 illustrates a representation of an alternative nonlimiting embodiment of a chemical reactor system for gas synthesis of the present invention: a simplified multi-vessel pseudo-batch reactor system of connected individual catalytic reactors for gas synthesis with separate entries for reactants and exit of reaction products.

FIG. 12 illustrates a representation of this alternative nonlimiting embodiment of a chemical reactor system for gas synthesis of the present invention: a multi-vessel pseudo-batch reactor system of connected individual catalytic reactors for gas synthesis with separate entries for reactants and exit of reaction products and reverse flow capabilities.

FIG. 13 illustrates a representation of this alternative nonlimiting embodiment of a chemical reactor system for gas synthesis of the present invention: a multi-vessel pseudo-batch reactor system of connected individual catalytic reactors for gas synthesis with separate entries for reactants and exit of reaction products and individually selectable reverse flow capabilities.

FIG. 14 illustrates a representation of this alternative nonlimiting embodiment of a chemical reactor system for gas synthesis of the present invention: a multi-vessel pseudo-batch reactor system of connected individual catalytic reactors for gas synthesis with separate entries for reactants and exit of reaction products and individually selectable reverse flow capabilities using multiport valves.

FIG. 15 illustrates a cross sectional view of one nonlimiting embodiment of an individual reactor pressure vessel used in the present invention and shown in FIGS. 11-14.

FIG. 16 illustrates a cross sectional view of a nonlimiting embodiment of an individual reactor pressure vessel used in the present invention as depicted in FIGS. 11-14 with an active cooling system included.

FIG. 17 is a process schematic of a nonlimiting example of an ammonia production system that illustrates how the chemical reactor system of FIGS. 11-14 interacts with other parts of the system.

FIG. 18 is a process schematic of one nonlimiting embodiment of a control system for the chemical reactor system of FIGS. 11-14 of the present invention.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Provided by this disclosure are chemical reactor systems for gas synthesis with a batch, pseudo-batch, temperature swing or dynamic reactor of one or more individual catalytic reactors for gas synthesis, one or more fluid control mechanisms of shared pipe and manifolds for delivery of reactants to and collection of reaction product from the chemical reactor system, and a control system capable of opening the one or more fluid control mechanisms to control entry of reactants to and exit of reaction products from the chemical reactor system. These chemical reactor systems can be coupled to variable or intermittent energy production technologies making them particularly useful as energy waste reduction systems. In one nonlimiting embodiment, coupling of a chemical reactor system of the present invention to a variable or intermittent energy production technology enables a Power-to-X (also P2X or P2Y) system. Power-to-X, P2X or P2Y can be defined as electricity conversion, energy storage, and/or reconversion systems from renewable energy. Nonlimiting examples of such energy production technologies include solar, wind, water and geothermal energy production technologies. Methods for use of these systems in gas synthesis, and in particular ammonia synthesis, and to retrofit ammonia synthesis plants are also provided. The disclosed chemical reactor systems, when used for ammonia (NH3) synthesis, enables the well established gas catalytic chemistry as used in most Haber-Bosch processes to be adapted to variable or intermittent renewable energy power sources.

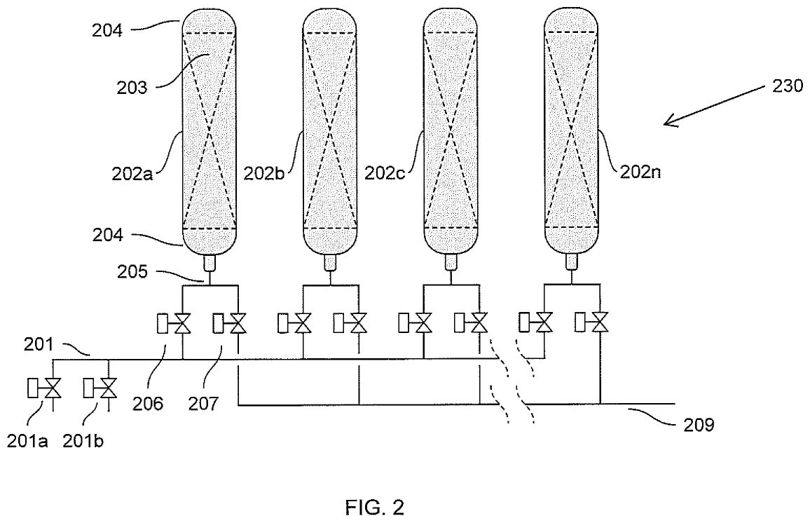

FIGS. 2 through 10 illustrate nonlimiting embodiments of a chemical reactor system 200 of this disclosure equipped with a multi-vessel temperature swing reactor system 230. As will be understood by the skilled artisan upon reading this disclosure, however, alternative embodiments comprising a single vessel reactor may be used in these chemical reactor systems and are considered to be within the scope of this invention.

With reference to FIG. 2, a plurality of reactor vessels 202a, 202b, 202c . . . 202n are connected to shared inlet 201 and outlet 209 manifolds by piping 205 with mechanisms to control the flow of reactants in 206 and out 207 of the vessels. In one nonlimiting embodiment each reactor vessel is equipped with inlet 206 and outlet 207 valves as these mechanisms. The inlet manifold 201 may be equipped with valves 201a, 201b to control the composition of reactants within the inlet manifold. Other embodiments may have duplicate inlet manifolds 201 and associated inlet valves 206 dedicated to each reactant. The orientation of the vessels, manifolds and piping may be optimized depending on the properties of the reaction, reactants, catalyst and heat transfer, among other constraints.

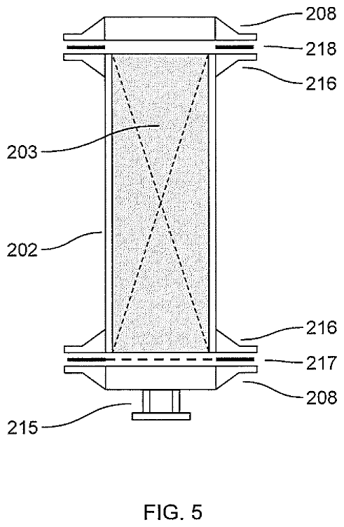

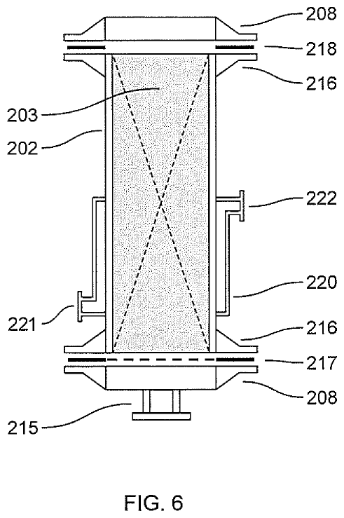

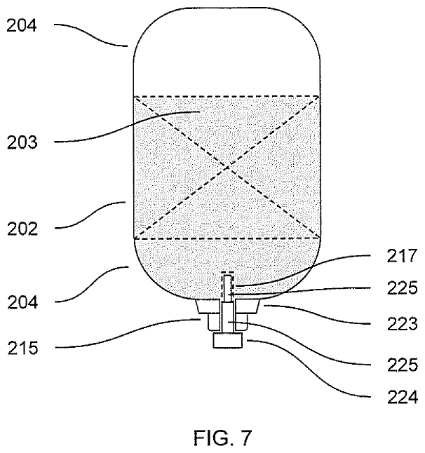

Each reactor vessel 202 consists of a hollow cylindrical section containing a catalyst 203 and equipped with fixed domes or heads 204 at each end. Some embodiments may feature removable or detachable heads at each end of the hollow cylinder. In one nonlimiting embodiment, the reactor vessel 202 is constructed from a standard hydrogen storage tank (see detail in FIG. 7). In another nonlimiting embodiment, the reactor vessel 202 is constructed using a length of nominal pipe (NPS or DN) and the heads 204 are constructed using standard pipe (e.g. ASME, DIN or EN) flanges (see detail in FIG. 5 or FIG. 6).

Individual reactor vessels are filled with synthesis feed gas by opening the dedicated inlet 206 valve that connects the reactor pressure vessel to the inlet manifold 201. The inlet valve 206 is opened for sufficient time to allow the incoming fluids from the inlet manifold 201 to enter and pressurize the vessel to the desired operating point after which the valve 206 is closed. The time taken to fill a given reactor vessel, for a system in series batch filling, is approximately equal to the mass of gas within the individual reactor vessel 202 at peak operating pressure divided by the overall mass flow rate through the system of reactors.

At the start of the filling sequence for a given reactor the internal pressure will be lower than at the end of the filling sequence; thus there will be a higher pressure differential across the inlet valve 206 at the start of the filling sequence than at the end.

For a system of reactor vessels operating in series fill, each reactor is filled in sequence via the same methodology with some overlap of inlet valve 206 opening between reactors to ensure continual flow at the inlet 201 manifold as required by upstream compression systems or other constraints. The pressure of the inlet manifold will fluctuate slightly as inlet valves open and close but will typically be at or around the desired reactor operating pressure within the reactors. The entry 206 and exit 207 valves of each reactor remain closed unless that specific reactor is being filled or emptied.

Once the reactor is filled with reactant gasses the reaction will proceed as long as the conditions are favorable to the given reaction. As a nonlimiting example, for ammonia synthesis this requires the reactants to be at sufficiently high pressure and temperature and in the presence of a suitable catalyst. For some nonlimiting embodiments of the present invention, the incoming reactants are heated prior to entry into the reactor; this may be as a result of temperature increase due to reactant compression (prior to entry into the reactor vessel) or from some other heat source. For some nonlimiting embodiments of the present invention a heat source internal or connected to the reactor body may be used to heat the reactants after they have been added to the reactor vessel (see detail in FIG. 5 or FIG. 6).

For ammonia synthesis, heat is released as the reaction progresses and the nitrogen and hydrogen reactants are turned into ammonia product. Depending on the volume of each reactor vessel, the heat release may need to be controlled to not exceed either practical or design temperature conditions. In addition, due to Le Chatelier's principle (see Le Chatelier's Principle at en with the extension .wikipedia.org/wiki/Le_Chatelier%27s_principle of the world wide web) for ammonia synthesis, high reactor temperatures will decrease the equilibrium conversion. To control the reactor temperature, one or more reactants can be added slowly to the reactor, for example at a rate that allows atmospheric cooling of the reactor body to match the heat released.

In one nonlimiting embodiment of the present invention, valve 201a is connected to high pressure hydrogen supply and valve 201b is connected to high pressure nitrogen supply. The reactor vessels are initially filled in sequence with hydrogen up to a desired pressure through valve 201a while valve 201b is closed; once all vessels are filled with hydrogen at operating pressure and temperature, valve 201a is closed. Subsequently, valve 201b is opened and each vessel has nitrogen added (via valve 206) at sufficiently low rates to keep a constant reaction temperature within each vessel.

For ammonia synthesis, the 0.5 molar ratio of products to reactants means the pressure within an adiabatic system may drop as the reaction proceeds (depending on system temperature); this allows nitrogen to be added to the reactor as the reaction progresses while maintaining the same approximate operating pressure without product removal. Once equilibrium conversion has been reached for the given reactor conditions, the nitrogen entry is stopped and the reactor allowed to cool below the ammonia product dew point or critical temperature (approximately 132 degrees Celsius) after which liquid ammonia product can be emptied from the reactor. Some nonlimiting embodiments of the present invention may fill the catalyst containing vessels with nitrogen first and progressively add hydrogen in a similar manner to the procedure described above.

For some nonlimiting embodiments of the present invention, all reactants are added as the reactor is initially filled and reaction progresses until equilibrium conversion is reached. For ammonia synthesis, energy is released as products are formed until equilibrium conversion is reached and no more ammonia product is formed. Depending on the rate of nitrogen added to the reactor the heat produced by the reaction may cause the reactor temperature to increase or stay the same; after reaction equilibrium is reached the reactor temperature will stabilize as the reaction slows or stops. Once the reactor starts to cool due to either atmospheric or any applied cooling, the reaction may start to progress forward to a new equilibrium conversion again according to Le Chatelier's principle (see Le Chatelier's Principle at en with the extension .wikipedia.org/wiki/Le_Chatelier%27s_principle of the world wide web). When final equilibrium conversion has been reached, the reactor is allowed to cool below the ammonia product dew point or critical temperature (approximately 132 degrees Celsius) whereby, depending on the ammonia partial pressure, the gaseous ammonia will turn to liquid, after which the liquid products can be emptied from the reactor.

The aim of reactor emptying for the present invention is to remove as much liquid phase ammonia product as possible, without allowing unreacted reactant gasses leaving the vessel via the outlet manifold. Once the ammonia cools below the critical temperature (or dew/bubble point, depending on the operating pressure) it will change phase from gas to liquid and settle to the bottom of the reactor vessel; the reactants will remain in the gaseous phase even down to well below atmospheric temperature at typical system operating pressures. The vessel outlet piping therefore needs to be located towards the bottom of the vessel (either externally as shown in FIGS. 2 through 7 or internally using some kind of bottom collector). Liquid phase product removal allows a relatively pure, high quality ammonia product to be extracted from the reactor vessels at high pressure without the need for significant product cooling, unreacted reactant gas recycle (and the associated equipment) as is the case for the current state-of-the-art.

Emptying the product from the reactor is completed by opening the mechanism or valve 207 connecting the reactor to the outlet manifold 209 once the reactor has cooled enough to allow liquid product to form; for most embodiments the inlet valve 206 remains closed during vessel emptying. The pressure in the outlet manifold is lower than the reactor vessel operating pressure, potentially at or around the product storage pressure which can be as low 15 bar, depending on the ambient temperature. The pressure differential between the reactor and the outlet manifold is the driving force that empties the vessel. In some nonlimiting embodiments of the present invention energy can be recovered as the product liquid depressurizes from the reactor pressure to the outlet manifold pressure.

At the start of the emptying sequence the pressure differential across the outlet mechanism or valve 207 will be highest and will decrease as the reactor empties. The outlet valve 207 is closed before all the liquid product is removed from each reactor to prevent unreacted gasses entering the outlet manifold 209. To determine when sufficient liquid product has been removed (and minimize unreacted gas exit), vessel level gauges of various types may be required. Once sufficient liquid product has been removed from the reactor, it can be refilled with (either externally or internally heated) reactants to the operating pressure which will allow more product to be produced.

For some nonlimiting embodiments, depending on the rate of filling, reaction, cooling and emptying, once the last reactor 202n has been filled, the first reactor 202a is re-filled which maintains a continual flow through the overall system. The control system must take into account the time taken to empty the reactor; in order to have continual flow the next reactor to be filled must be proactively emptied prior to filling. The non-moving residence time of each reactor vessel is thus approximately equal to the individual reactor fill time multiplied by the number of subsequent reactors.

For a system operated with series filling, the average residence time available is a function of the sum of the catalyst volume of all reactors divided by the overall fluid rate through the system. For a given throughput and target residence time (and thus catalyst volume) the number of series filled reactors selected for the system is an optimisation between the desired non-moving residence time and the limitations of reactor filling.

Reactor filling and emptying will be limited to some maximum rate determined by acceptable pressure drop through the catalyst bed, limits to potential catalyst damage or entrainment, vessel pressure change limits or some other physical criteria (such as speed of valve opening/closing during the filling sequence). For some nonlimiting embodiments of the present invention filling groups of reactors in parallel will be desirable.

This nonlimiting embodiment of the current invention can also be used to have flow between reactors using either the inlet or the outlet manifolds during periods of downtime (for example at night or low wind periods when there is no variable or intermittent renewable energy available). In one nonlimiting example, reactor 202a is emptied to reactor 202b via the inlet manifold during a time when the upstream compression (not shown in FIG. 2) is shutdown. For this (and other scenarios) to work, flow must be made from a high pressure reactor to a low pressure reactor. In this example scenario reactor 202a is operating at a higher pressure than reactor 202b with all reactors operating in batch mode (all reactor inlet/outlet valves are closed).

In one nonlimiting embodiment of the present invention, a number of the reactors are filled with one reactant only (e.g. hydrogen) during the day to a pressure higher than the normal reactor operating pressure (for example 350 barg or 700 barg) with a portion of the reactors filled to normal operating pressure with both reactants. During periods when no power is available, once a given reactor has been emptied of product, gas from a higher pressure reactor is emptied into the inlet manifold to refill the empty reactor and so on; once all higher pressure filled reactors have been emptied down to normal operating pressure they can all be used to produce products by adding nitrogen progressively. This operating scenario allows a smaller number of reactors to be used to store reactants at higher density for “offline” production.

To complete the reactor-to-reactor gas transfer, valve 206a is opened to connect the inlet manifold 201 to line 205a while valve 207 is closed. On reactor 202b valve 206b is positioned to connect the inlet manifold 201 to line 205b; valve 207b closed. Gas flows from reactor 202a to the inlet manifold 201 via piping 205a and valve 206a and then into reactor 202b via valve 206b and piping 205b. The gas will stop flowing between reactors 202a and 202b when the pressure differential is exhausted; the final operating pressure will be somewhere between the two starting pressures, depending on the relative volumes, catalyst void fraction and gas compositions of the two reactors. In some nonlimiting embodiments of the present invention a single multiport valve replace valves 206 and 207.

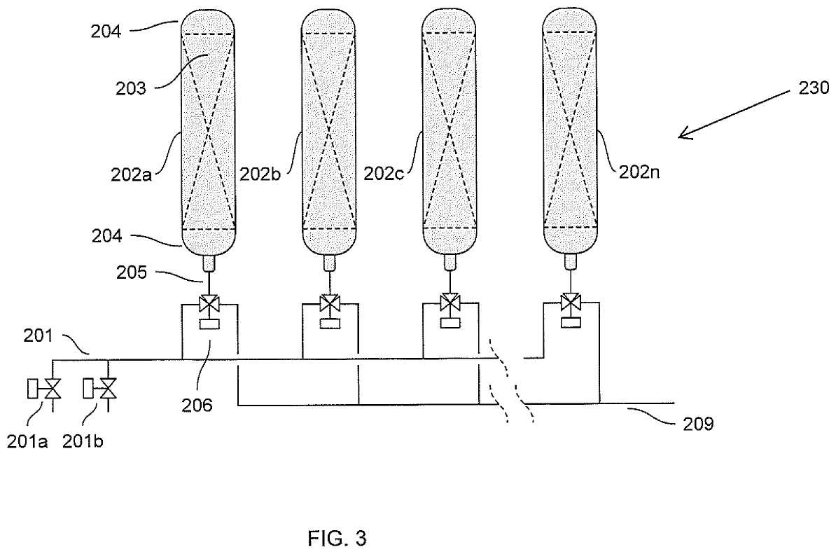

FIG. 3 illustrates this nonlimiting embodiment of the present invention: a multi-vessel temperature swing ammonia synthesis reactor system 230 using multiport valves.

With reference to FIG. 3, a nonlimiting embodiment of the present invention is illustrated, similar to FIG. 2, using multi-port valves for filling and emptying of the individual reactor vessels. An advantage of the nonlimiting embodiment shown in FIG. 3 over that shown in FIG. 2 is that individual reactors can be selected for filling or emptying at any time while using a single valve or mechanism for the purpose.

As a nonlimiting example, to fill individual reactor 202a reactant gasses flow via manifold 201 through valve 206 which is positioned to connect the inlet manifold reactor line 201 to the reactor via inlet piping 205; in this position the connection between line 205 and outlet manifold 209 is closed. The incoming gasses pressurize the reactor vessel 202 from an initial pressure up to operating pressure as the reactor is filled. As the other reactors (202b, 202c . . . 202n) are being filled reactor 202a can be emptied at any point by changing the position of valve 206 so that line 205 is opened to the outlet manifold 209 and closed to the inlet manifold 201. The high pressure in the reactor 202 pushes reacted product gasses out through valve 206 via manifold towards the lower outlet manifold 209 which operates at lower pressure.

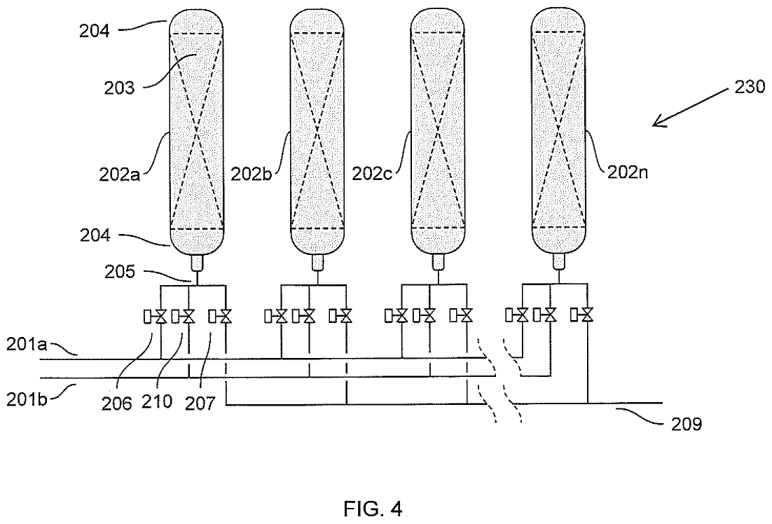

FIG. 4 illustrates another nonlimiting embodiment of the present invention: a multi-vessel temperature swing ammonia synthesis reactor system 230 with multiple inlet manifolds.

With reference to FIG. 4, a nonlimiting embodiment of the present invention is illustrated, similar to FIG. 2, but equipped with multiple manifolds for filling the individual reactor vessels. An advantage of the nonlimiting embodiment shown in FIG. 4 over that shown in FIG. 2 is that one reactant (for example nitrogen) can be added to individual reactors while other reactors are being filled with a different reactant (for example hydrogen).

As a nonlimiting example, inlet manifold 201a is dedicated to hydrogen gas, while inlet manifold 201b is dedicated to nitrogen gas. In this scenario, reactor 202a is initially filled with hydrogen reactant which flows via manifold 201a through valve 206 into the reactor via piping 205 while the nitrogen inlet valve 210 and the outlet manifold valve 207 remain closed. The incoming hydrogen gas pressurizes the reactor vessel 202a from a lower initial pressure up to a higher operating pressure as the reactor is filled. Once reactor 202a is filled, the nitrogen reactant can be introduced to reactor 202a via the nitrogen manifold 201b through the dedicated nitrogen inlet valve 210. An advantage of the nonlimiting embodiment of the present invention illustrated in FIG. 4 is that other reactors (for example 202b, 202c . . . 202n) can be filled either in series or in parallel with hydrogen using their dedicated hydrogen manifold inlet valves while other reactors (202a for example) are being filled with nitrogen. A further advantage of this nonlimiting embodiment of the present invention is that hydrogen and nitrogen can be added in parallel and in varying ratios to individual reactors as required by either current state of the reaction or a specifically desired reactant ratio.

Once the reaction has progressed sufficiently, no more nitrogen is added and the reactor is allowed to cool below the critical temperature which allows the ammonia product to condense from gaseous to liquid state. The individual reactors can be emptied of liquid product ammonia to the outlet manifold 209 by closing their dedicated inlet valves 206, 210 and opening the outlet valve 207. The high pressure in the reactor 202 pushes reacted product gasses out through valve 207 via manifold towards the lower outlet manifold 209 which operates at lower pressure.

FIG. 5 illustrates a cross sectional view of a nonlimiting embodiment of an individual reactor pressure vessel used in the present invention.

With reference to FIG. 5, in this embodiment the reactor vessel 202 is a pressure vessel made up of a cylindrical shell fitted with flanges 216 at each end to which heads 208 are attached. In one nonlimiting embodiment the heads 208 are removable. The pressure vessel heads are equipped with one or more means 215 such as nozzles to connect piping for fluid entry and exit; some nonlimiting embodiments may have one or more means 215 such as nozzles at both ends. The pressure vessel shell contains within a catalyst bed 203 between the pressure vessel heads. In some nonlimiting embodiments the catalyst bed completely fills the vessel, in other nonlimiting embodiments the catalyst only occupies a portion of the vessel volume to enable a higher average void fraction and increased gas capacity. The catalyst is prevented from exiting the pressure vessel during operation by catalyst holders or grating 217 at each end. One head may be equipped with a standard flange gasket 218.

In one nonlimiting embodiment the catalyst grating 217 is located in between the pressure vessel flanges 216, gasket 218 and heads 208; in another nonlimiting embodiment the grating may be integral to a gasket that creates a seal between the pressure vessel flanges and heads. In a preferred embodiment to reduce cost and requirements of custom design, manufacture and testing, the reactor vessel 202 is constructed using a length of nominal pipe (NPS or DN) and the flanges 208 and heads 508 are constructed using standard pipe flanges (e.g. ASME, DIN or EN). The ability to use nominal pipe and standard flanges is enabled by the multi-vessel reactor system described in the present invention.

FIG. 6 illustrates a cross sectional view of a nonlimiting embodiment of an individual reactor pressure vessel used in the present invention with an active cooling or heating system included.

With reference to FIG. 6, a nonlimiting embodiment of the individual reactor vessels used in the present invention is illustrated, similar to FIG. 5, with the addition of an active heat transfer system. As per FIG. 5 the reactor vessel 202 is a pressure vessel made up of a cylindrical shell fitted with flanges 216 at each end to which heads 208 are attached. The pressure vessel heads are equipped with one or more nozzles 215 to connect piping for fluid entry and exit; some embodiments may have one or more nozzles 215 at both ends. In one nonlimiting embodiment a hollow external pipe 220 equipped with inlet nozzles 221 and outlet nozzles 222 covers a portion of the cylindrical shell of the reactor vessel 202. Heat transfer medium flows via nozzle 221 into the external pipe 220 where it contacts the pressure vessel shell. In one nonlimiting embodiment used for reactor cooling, cool heat transfer medium is passed into the heat transfer system of external pipe 220 via nozzle 221 where it is heated, cooling the reactor vessel 202 and its contents. The flow of the heat transfer medium is controlled either continuously or by batch flow using a valve on the outlet (not shown here). In some embodiments, the addition of a heat transfer medium to the jacket can be used for increased thermal inertia during reactor operation even if the medium does not flow during normal operation.

FIG. 7 illustrates a cross sectional view of an embodiment of an individual reactor used in the present invention where a typical pressurized gas storage tank is filled with catalyst for use as a reactor pressure vessel as shown in FIG. 2, FIG. 3 and FIG. 4.

With reference to FIG. 7, in this embodiment a pressure vessel is made up of a typical gas storage tank such as the style used for storing compressed hydrogen. The system presented here could apply to all types of hydrogen storage from Type 1 (metal only) through to Type 5 (composite).

In one nonlimiting embodiment of the present, a cylindrical shell of a reactor vessel 202 is fitted with fixed domes or heads 204 at each end. One head of the reactor vessel is equipped with a collar 223 and a nozzle 215 to facilitate connection of a valve 224 and/or valve piping 225 for fluid entry and exit. The pressure vessel shell is either completely or partially filled with a catalyst bed 203 between the pressure vessel heads. In a preferred embodiment catalyst filling is completed through a tank nozzle after cylinder manufacture, but prior to installing valves or piping. The catalyst is prevented from exiting the pressure vessel or blocking the gas exit holes during operation by some kind of grating, shield, perforated or slotted cover 217 near or over the nozzle.

In one nonlimiting embodiment the catalyst grating 217 is located around the piping 225 that is typically screwed into the cylinder or tank nozzle. In some nonlimiting embodiments, a portion of the valve piping 225 is reduced in diameter to allow a sheath of grating 217 around it which allows gas entry at more than one point along the piping, without the risk of catalyst beads blocking the piping (as would be the case for a single outlet hole without the grating). In this nonlimiting embodiment, the narrower section of piping and the grating are sized to be smaller than the internal diameter of the cylinder nozzle to enable fitting and removal after cylinder manufacture.

The ability to use standard high pressure gas storage cylinders (Types 1 through to Type 5) is enabled by the multi-vessel reactor system described in the present invention since the use of cyclical “static gas catalysis” allows smaller reactor vessels, with a single inlet/outlet nozzle to be used for a larger overall processing rate without the requirement for large custom designed reactor vessels.

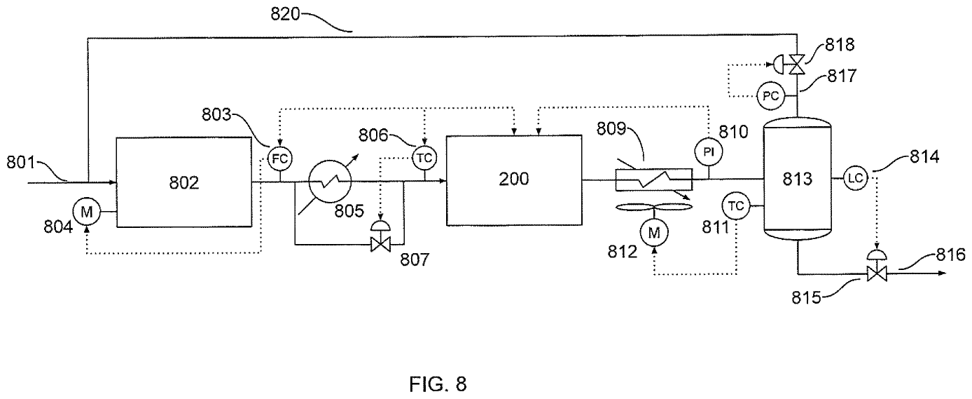

FIG. 8 is a process schematic of a nonlimiting example of an ammonia production system that illustrates how the present invention interacts with other parts of the system. As will be understood by the skilled artisan upon reading this disclosure, chemical reactor systems of the present invention can be routinely integrated into gas synthesis systems other than ammonia in a similar manner.

With reference to FIG. 8, in this nonlimiting embodiment of an ammonia production system using the present invention, hydrogen and nitrogen feed gas are supplied to the system 801 and combined with recycled, unreacted feed gas 820 before being fed to a feed gas compressor system 802. In one nonlimiting embodiment the feed gas compressor 802 may be driven by a variable speed motor 804 and controlled by a flow controller 803 on the compressor outlet. In some nonlimiting embodiments the hydrogen and nitrogen may be supplied to the gas compressor system 802 by separate inlet manifolds and be compressed sequentially; other embodiments may use a separate compressor for each reactant feed gas.

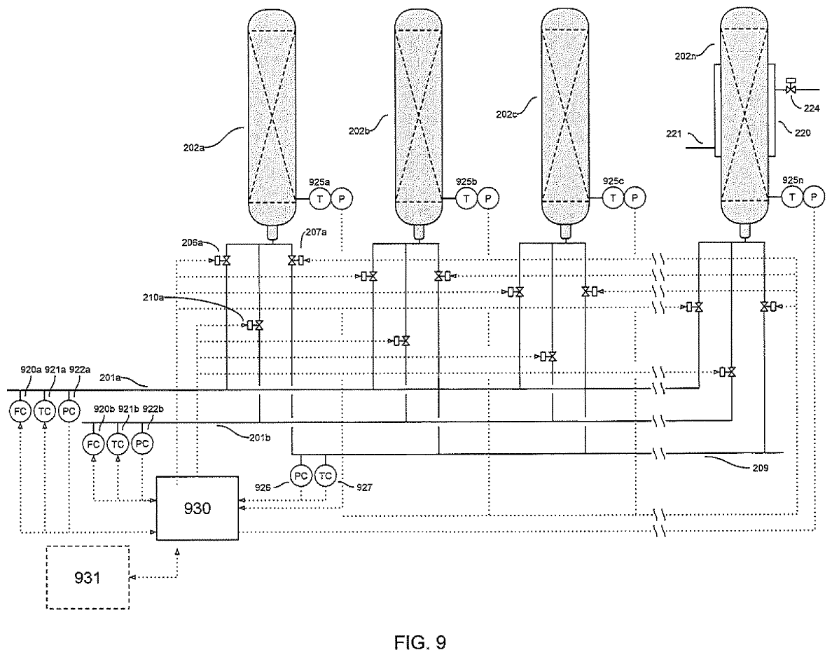

The operating pressure of the reactor system is typically controlled by a pressure controller inside the synthesis reactor unit 200; in one nonlimiting embodiment this is controlled by the compressor 802 flow rate 803 and hence output pressure via the motor control 804. Details of one nonlimiting embodiment are show in FIG. 9.

Pressurized feed gasses pass through an optional feed gas heat exchanger 805 to heat or cool the feed gasses to a desired temperature as required. In one nonlimiting embodiment a temperature controller 806 controls a bypass 807 around the feed gas heat exchanger to optimize the temperature of feed gasses entering the chemical reactor system 200; reactant gasses are further heated within the gas synthesis reactor system 200. In some nonlimiting embodiments, the lower operating temperature required within the longer residence time of the pseudo-batch reactor system allows the feed gas to be heated by the gas compression stage 802 without the need for the pre-heater 805 (805). In other nonlimiting embodiments, the reactors within the system are individually heated with either jackets or some other method (as described for example in FIG. 6) again without the need for the pre-heater 805.

Product and any unreacted feed gasses within the synthesis reactor system 200 are primarily cooled by ambient temperature while still resident in the reactors (to allow product to change from gaseous to liquid phase) but they can be additionally cooled or sub-cooled in a product gas cooler 809. In one nonlimiting embodiment this may be an air cooler driven by a variable drive motor 812 controlled by a downstream temperature controller 811.

Cooled product fluids are passed to a gas-liquid separator 813 where liquids are separated from unreacted hydrogen and nitrogen gasses. The level in the gas-liquid separator is controlled by a level controller 814 with a level control valve 815; liquid ammonia product leaves the system 816.

In some nonlimiting embodiments of the present invention, the pressure of the system downstream of the reactor system 200 including the product gas-liquid separator is controlled by a pressure controller 817 and control valve 818 with the separator operating conditions (pressure and temperature) set to ensure ammonia is liquid while any unreacted hydrogen and nitrogen are in gaseous state. Unreacted hydrogen and nitrogen gasses are recycled to the inlet feed gas compressor 820.

In this nonlimiting embodiment of the present invention within an ammonia production system, the reactor system 200 receives data and controls setpoints of the feed gas compressor flow control 803, the feed gas heat exchanger bypass temperature controller 806 and the downstream system pressure 810. As a nonlimiting example, the reactor system 200 may interact with the compressor flow controller 803 by increasing the compressor flow rate setpoint in order to decrease the reactor residence times, or vice versa. Likewise the reactor system 200 may decrease feed gas heater temperature control setpoint to lower the feed gas inlet temperature as the system throughput decreases and reactor residence times (and thus reaction conversion) increases.

Further details of various nonlimiting embodiments of the present invention control systems are outlined in FIG. 9 which shows a process schematic of one nonlimiting embodiment of the control system for a temperature swing reactor such as described in FIG. 2.

With reference to FIG. 9, in this nonlimiting embodiment of an ammonia production system the flow of gas through a plurality of pressure vessel reactors 202a-n is controlled by a local system controller 930, using a series of inlet 206a-n and outlet 207a-n mechanisms and various sensors 925, with input from a remote controller 931.

This nonlimiting embodiment of the present invention includes two separate inlet manifolds 201a, 201b as described in FIG. 4; alternative embodiments of the present invention may only include a single inlet manifold (as described in FIG. 2).

During normal operation, pressurized synthesis feed gas is supplied to the inlet manifolds 201a, 201b. The flow rate and temperature of the fluids entering the system are set by upstream system controllers 920a, 920b, 921a, 921b with input from the local system controller 930. The flow rate and pressure at the inlet manifolds 201a, 201b is monitored via pressure 922a, 922b and flow 920a, 920b transmitters to determine that flow into the system matches system capacity. For example an increase in inlet manifold pressure would inform the local controller 930 to lower the output flow rate set point of any upstream compression system in the flow controller 920.

In a nonlimiting example sequence to fill the reactors with hydrogen first and then nitrogen (as described in FIG. 4) once the inlet manifold 201a for hydrogen is at operating pressure the local controller 930 opens the inlet valve 206a for hydrogen on the first reactor 202a causing hydrogen gas to flow into and the internal pressure to rise in that individual reactor. The temperature of the hydrogen in the manifold will be close to the desired reactor operating temperature, in the order of 200-300° C., depending on the upstream compression system efficiency.

In some nonlimiting embodiments, the local controller 930 can measure reactor conditions from sensors such as inlet pressure 925a, manifold temperatures, reactor temperature 925a and the flow of gas to the reactor 920a, 920b; using this data it calculates the time remaining to fill the reactor with new synthesis gas. The inlet valve 206a is programmed to close once the reactor operating pressure has been reached; the valve starts closing in order to be fully closed at the target operating pressure. As the inlet valve 206a is closing on the first reactor 202a the system starts opening the inlet valve 206b on the second reactor 202b. The sequence repeats for reactors 202c and so on until the last reactor 202n is filled; this completes a single filling cycle. In some embodiments, depending on the required residence time for filling, reaction and system cooling, once each cycle is completed the first reactor 202a is emptied and refilled using the same technique.

When a given reactor (in this example 202a is filled with enough hydrogen gas from manifold 201a to reach operating pressure (and valve 206a is closed) nitrogen gas can be gradually introduced to the reactor by opening valve 210a. Once nitrogen is added to the hot hydrogen filled reactor the exothermic reaction will start, releasing heat as ammonia is produced causing the temperature of the reactants, products, catalyst and reactor vessel to rise.

Some of the heat produced by the exothermic reaction will be lost through the reactor walls to the environment, depending on the reactor material, design and any insulation. The reactor temperature must be maintained at an operating temperature that is sufficiently high to maintain the reaction but low enough to achieve a good equilibrium conversion. Nitrogen is added to the reactor at a controlled rate to keep the temperature at the desired temperature; it can be added continuously, in pulses or some other way. For ammonia synthesis, the 0.5 molar ratio of products to reactants means the pressure within an adiabatic system will drop as the reaction proceeds; nitrogen can therefore be added to maintain sufficient operating pressure.

The local controller 930 monitors the reaction progression via temperature and pressure measurements 925a-n; some nonlimiting embodiments of the present invention may have more than a single temperature indicator to ensure accurate monitoring of the entire reactor length. The entry of nitrogen to the reactor is controlled to maintain a desired set of operating conditions. Some nonlimiting embodiments of the present invention may add significant nitrogen initially to cause a high temperature (and therefore initial reaction rate) before allowing the reactor to cool slightly towards the end of a batch production cycle and increase the equilibrium conversion.

When the reaction has progressed to the desired point (for example as equilibrium conversion is reached), the nitrogen inlet valve is closed, the reaction will slow and eventually the reactants, products, catalyst and reactor vessel will start to cool as more heat is lost to the environment than is being produced by the exothermic reaction. As the temperature of the reactor falls below either the critical temperature (approximately 132° C.) or the ammonia dew point temperature for the given internal pressure, liquid ammonia products will condense in the reactor. Liquids will condense towards the bottom of the reactor, allowing drainage to the outlet manifold 209.

Emptying the reactor (for example the first reactor shown, 202a) involves opening the outlet valve 207a for sufficient time to allow as much ammonia liquid to leave as possible, without allowing unreacted gasses to escape. Some nonlimiting embodiments may include a level measurement system on the reactors (not shown in FIG. 9) to allow the outlet valve to be closed once a low liquid level is reached, other nonlimiting embodiments may use algorithms to predict liquid levels and evacuation rates. Any gas that is released along with the ammonia liquid will be recycled via a gas/liquid separator downstream of the reactors, operating at a lower pressure.

As liquid ammonia leaves the reactor, the pressure will drop inside the reactor; the temperature of the catalyst and reactor body may be lowered during the emptying process by the reduction in pressure gas (depending on the hydrogen content in the unreacted gas due to reverse Joule-Thompson effect). Once the reactor has been emptied of as much liquid ammonia as possible, the refilling process described above can restart. Some nonlimiting embodiments of the present invention may have sufficient reactor volume (or number of reactors) to store all the hydrogen available for the given upstream hydrogen production system and available daily energy. In this nonlimiting embodiment once a given reactor is filled to the desired operating pressure, only sufficient nitrogen is added to maintain the desired operating temperature, with the reaction progressing at a slow pace during periods of low energy availability (e.g. overnight for solar energy systems) in order to increase equilibrium conversion. In this operating scenario, reactor refilling will only occur once sufficient energy is available for hydrogen production (e.g. once the sun rises for solar energy systems).

Some nonlimiting embodiments may have different operating pressures between reactors to optimize ammonia production and equilibrium conversion. Some nonlimiting embodiments may use some reactors for storage of hydrogen at high pressure and others for ammonia production at a lower operating pressure. In one nonlimiting example, reactor 202a is filled with hydrogen to 700 bar with no nitrogen added, while reactor 202b is filled with hydrogen to 250 bar with nitrogen introduced to produce ammonia. Once reactor 202b has gone through a cycle of filling, reaction and emptying, the reactor pressure will be lower than the desired 250 operating pressure; it can be refilled during periods of compressor downtime from reactor 202a by opening valve 206a which will allow the gas in reactor 202a to pressurize the inlet manifold 201a for hydrogen. This can be repeated until the internal pressure of reactor 202a has lowered enough to allow it to operate as a reaction vessel (with nitrogen introduced to produce ammonia). Some nonlimiting embodiments may use a portion of their reactor vessels for high pressure hydrogen storage and the remainder for ammonia production.

Some nonlimiting embodiments of the system may have additional heat transfer mechanisms as illustrated on one vessel 202n, such as a hollow outer pipe 220 or a sleeve or jacket on the reactor that is filled with heat transfer fluid connected to a cooling or heating loop that enables active reactor temperature control. The heat transfer jacket has inlet piping 221, outlet piping 222 and valving 224 to control the flow of heat transfer medium. In some nonlimiting embodiments of the reactor system all reactors are equipped with this active cooling mechanism; in other nonlimiting embodiments only a portion of reactors are equipped with active cooling. The active cooling system may also be used to either rapidly cool products once the desired reaction progression has been reached or for reactor heating during system start-up.

To operate the reactor heat transfer system, the local controller 930 opens the heat transfer medium control valve 224 to ensure heat transfer medium flows at a sufficient rate to keep the reactor temperature controlled, increased or decreased. In some nonlimiting embodiments the active heating or cooling system may be used to maintain constant reactor temperature (isothermal operation). The local controller 930 may set the active heat transfer system to cool the reactor or slow the reactor temperature increase once a given temperature has been reached. This allows the equilibrium conversion to be increased beyond pure adiabatic operation which would require the expulsion of the reactor contents at a given temperature to maintain reactor and catalyst temperature below a certain value (such as catalyst sintering temperature).

Some nonlimiting embodiments of the system may include connection of the local controller 930 to a remote controller 931 that receives data from and sends data to a number of systems operating in parallel. In some nonlimiting embodiments the remote controller may be cloud based. The remote controller 931 can be used to collect data from non-system specific sources, such as weather tracking systems or databases, performance data of other reactor systems operating nearby or local renewable energy power demand curves and use these inputs to make predictions of required reactor system performance conditions or setpoints. Some nonlimiting embodiments of the system may make use of artificial intelligence within or by the remote controller 931 to help generate predictive control setpoints for the local controller 930; other nonlimiting embodiments may use the remote controller for centralized compute power to enable lower cost local controllers.

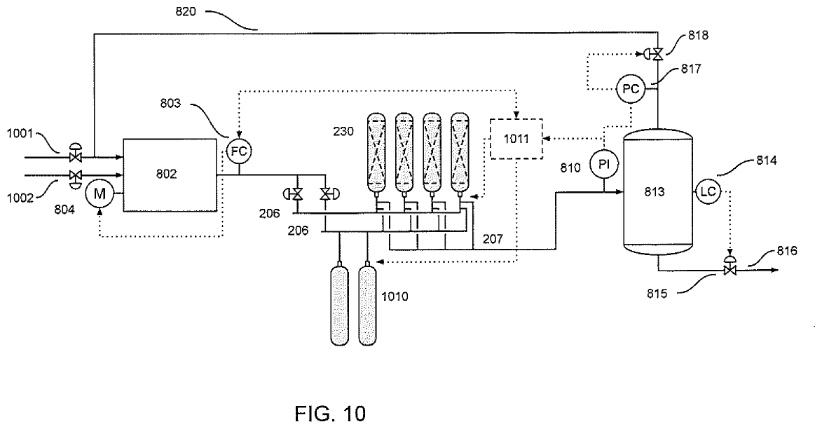

FIG. 10 is a process schematic of one nonlimiting embodiment of the present invention for an ammonia synthesis system that enables production during periods of low power availability (e.g. overnight ammonia production for solar powered systems). As will be understood by the skilled artisan upon reading this disclosure, this process using a chemical reactor system of the present invention can be routinely adapted to gas synthesis processes other than ammonia in a similar manner.

With reference to FIG. 10, in this nonlimiting embodiment of an ammonia production system using the present invention, a compression system 802 is supplied by hydrogen 1001 and nitrogen 1002 feed gas via separate manifolds. The hydrogen feed gas source (typically from some kind of water electrolysis system) is combined with recycled, unreacted feed gas 820. In one nonlimiting embodiment the feed gas compressor 802 is driven by a variable speed motor 804 and controlled by a flow controller 803 on the compressor outlet. The nonlimiting embodiment shown here has a single compressor used alternatively for both hydrogen and nitrogen; some nonlimiting embodiments may use a separate compressor for each reactant feed gas.

When power is available, hydrogen is produced (upstream of this schematic), supplied to the feed gas compressor 802 via the hydrogen manifold 1001, directed to the reactor manifold (206 for hydrogen and used to fill the reactors 230 for ammonia either in series, parallel or some combination. In this nonlimiting embodiment the reactor vessels are standard hydrogen tanks, filled or partially filled with ammonia synthesis catalyst. The hydrogen tanks are inverted to ensure the single inlet and outlet nozzle is located at the bottom of the tank to enable draining of liquid ammonia without the need for an internal standpipe. Some other embodiments may use an internal standpipe with non-inverted tanks.

Once sufficient hydrogen has been pressurized and stored within the reactors, and while power is still available, nitrogen is produced (upstream of this schematic), passed to the compressor via the dedicated nitrogen compression manifold 1002, compressed in the feed gas compressor 802, directed to the reactor manifold 210 for nitrogen and used to fill nitrogen storage cylinders 1010. The nitrogen is compressed to sufficiently high pressure above the normal reactor operating pressure to enable nitrogen flow from the storage cylinders 1010 into the temperature swing reactors 230 without the need for further compression. Some methods may compress and store nitrogen prior to the hydrogen; systems with dedicated or parallel compressors can choose to do both tasks simultaneously.

When the first ammonia reactor is filled sufficiently with hydrogen (and recycled unreacted gasses) to reach a minimum desired operational pressure, and before the hot compressed gas cools in the reactor, nitrogen can start being introduced into the reactor from the nitrogen manifold. The amount of nitrogen introduced into a given reactor should be enough to maintain the reactor at the desired operating temperature through the exothermic heat released by the ammonia synthesis reaction; the exothermic heat released to atmosphere from the reactor should be replaced by the heat released from the synthesis reaction. As ammonia is produced the pressure within the reactor will drop and the temperature will rise, nitrogen can be added using feedback or predictive control based on temperature, pressure or a combination of both.

During periods of low or no power availability (such as once the sun sets on a solar energy field) the nitrogen can be introduced gradually to the reactors to continue to produce ammonia, without the need for ongoing compression power. The only power requirement will be for the control systems 1011 and valve actuators (not shown in this schematic-see FIG. 9) which can also be driven by compressed air or nitrogen. Due to the low capacity factor of systems linked to intermittent renewable power (typically in the order of 30% capacity factor or 12-17 hours without full power), the rate of reaction can be reduced significantly by lowering the reaction temperature to match the time available. Lowering the temperature will also increase the equilibrium conversion. The use of the present invention of pseudo-batch packed bed reactors enables this significant advantage over the current state-of-the-art plug flow steady state reactor systems.

When the reaction has reached the desired equilibrium conversion, the addition of nitrogen to the reactor can stop and the reactor is allowed to cool while the reactor is still closed; the pressure may drop slightly due to the decrease in temperature. Once the reactor, catalyst and gasses cool below the ammonia critical temperature (or bubble/dew point, depending on the ammonia partial pressure) the ammonia will change to liquid phase and can be drained from the reactor to the outlet manifold 207. Depending on the operating conditions, catalyst, reactor sizing, speed of reaction and desired equilibrium conversion, multiple temperature swing cycles may be completed during periods of available power (e.g. during the day for a solar powered facility). The use of the method described herein is not limited to periods of low or no power.

Liquid ammonia exits the reactor through control valves dedicated to each reactor (not shown here) to the outlet manifold 207. In this nonlimiting embodiment, the outlet manifold is controlled 817, 818, 810 at a lower pressure than the reactor operating conditions meaning some dissolved or unreacted gasses may flash out of the ammonia. The liquid is passed to a gas/liquid separator 813 from where any unreacted gasses are recycled 820 to the compression system 802 via the hydrogen feed manifold 1001. The remaining liquid ammonia passes from the separator under level control 814 via a control valve 815 through the liquid outlet manifold 816 to ammonia storage tanks (not shown). Depending on efficiency and environmental concerns, some embodiments may forgo recycling of any unreacted gasses during periods of low power and choose to vent any unreacted gasses from the gas/liquid separator 813 during periods when compression is not available.

Some nonlimiting embodiments of the present invention using high pressure hydrogen storage tanks (such as standard 700 bar Type 1 through 5 hydrogen tanks) will allow some reactors to be filled to a significantly higher pressure than the normal reactor operating conditions (as described in FIG. 9). This allows flow from higher pressure reactors to refill lower pressure reactors that have been emptied without the need to have the compression system running. Storing the hydrogen at higher pressure also allows a smaller overall system of reactors to be used; some nonlimiting embodiments may have multiple types of reactors with some designed for low pressure ammonia production only and others designed for higher pressure storage and ammonia production.

The use of this nonlimiting embodiment of temperature swing reactor in the chemical reactor systems of the present invention allows longer residence times and slower reaction rates within individual reactors, including cooling of the product gasses to ambient temperature, below liquid formation temperature, once reaction equilibrium has been reached. This reactor design of the present invention allows liquid ammonia to be extracted from the reactor, separate from unreacted feed gasses, without the need for complex cooling, or high recycle rates.

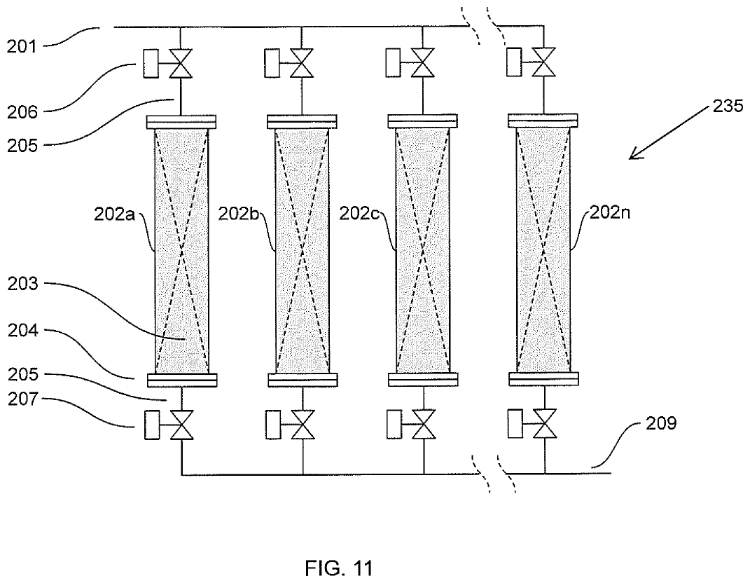

FIGS. 11 through 18 illustrate an alternative nonlimiting embodiment of a chemical reactor system 200 of this disclosure equipped with a multi-vessel pseudo-batch reactor system of the present invention with separate entries for reactants and exit of reaction products 235.

With reference to FIG. 11, a plurality of simplified reactor vessels 202a, 202b, 202c . . . 202n are connected to shared inlet 201 and outlet 209 manifolds by piping 205 at each end of the vessels. In one embodiment each reactor vessel is equipped with valves at the inlet 206 and outlet 207. The orientation of the vessels, manifolds and piping may be optimized depending on the properties of the reaction, reactants, catalyst and heat transfer, among other constraints.

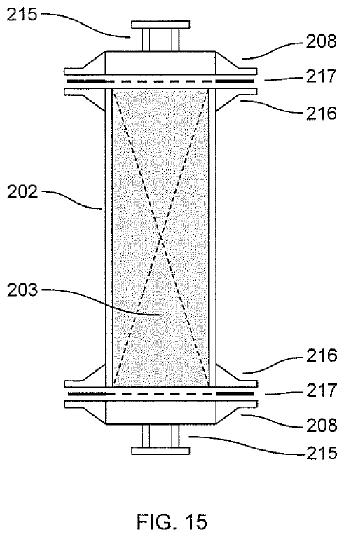

Similar to the temperature swing reactor system described above, each reactor vessel 202 of this system 235 may be comprised of a hollow cylindrical section filled with a catalyst 203 and equipped with heads 204 at each end. In one nonlimiting embodiment, the reactor vessel 202 is constructed using a length of nominal pipe (NPS or DN) and the heads 204 are constructed using standard pipe flanges (eg. ASME, DIN or EN). In one nonlimiting embodiment the heads 204 at each end of the reactor vessel 202 are equipped with a grating 217 to prevent the catalyst exiting the vessel. In one nonlimiting embodiment the grating and head gasket is integral (see detail in FIG. 15).

Reactor vessels are filled individually with synthesis feed gas by opening their dedicated inlet 206 and outlet 207 valves for sufficient time and with sufficient overlap to allow the incoming fluids from the inlet manifold 201 to expel the contents of the reactor vessel to the outlet manifold 209 as they enter the vessel, after which the valves are closed. The time taken to fill/empty a given reactor vessel, for a system in series batch filling, is approximately equal to the volume of said reactor vessel divided by the overall volumetric flow rate through the system of reactors.

For a system of reactor vessels operating in series fill, each reactor is filled in sequence via the same methodology with some overlap in valve opening between reactors to ensure continual flow at the inlet and outlet manifolds as required by upstream compression systems or other constraints; the entry and exit valves of each reactor remain closed unless that specific reactor is being filled. In a nonlimiting example sequence, once the last reactor 202n has been filled, the first reactor 202a is re-filled thereby expelling the reaction products to the outlet manifold 209, which maintains a continual flow through the overall system. The non-moving batch residence time of each reactor vessel is thus approximately equal to the individual reactor fill time multiplied by the number of subsequent reactors.

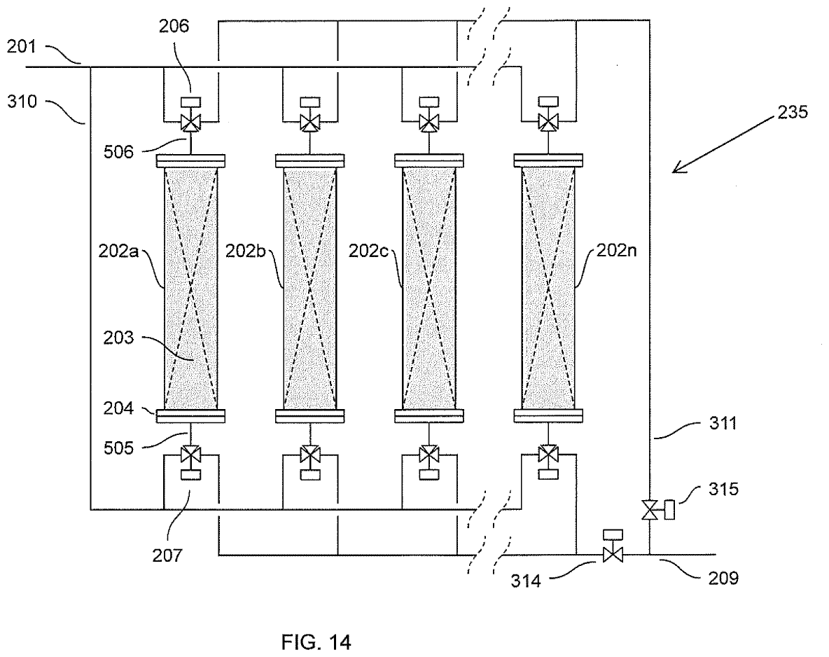

There is, by design, little change in pressure throughout the system, thus the inlet and outlet valves do not have significant pressure differential across them; nor do they need to provide a completely impermeable seal when closed. The role of the inlet and outlet valves is not primarily to contain pressure but to direct gasses to the desired reactor in the desired sequence and to ensure a minimum residence time within each reactor vessel. This makes the system suited to multiport valves, as illustrated in FIG. 14.

For a system operated with series filling, the average residence time is a function of the sum of the catalyst volume of all reactors divided by the overall fluid rate through the system. For a given throughput and target residence time (and thus catalyst volume) the number of series filled reactors selected for the system is an optimisation between the desired non-moving residence time and the limitations of reactor filling.

Reactor filling will be limited to some maximum rate determined by acceptable pressure drop through the catalyst bed, limits to potential catalyst damage or entrainment or some other physical criteria (such as speed of valve opening/closing during the filling sequence). For some embodiments of the present invention filling groups of reactors in parallel will be desirable.

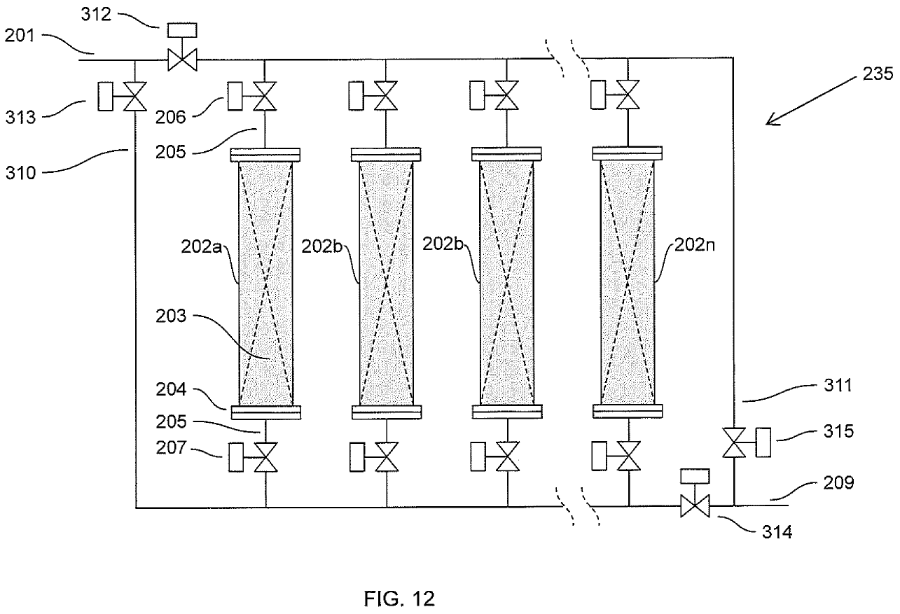

FIG. 12 illustrates a nonlimiting embodiment of a multi-vessel pseudo-batch reactor system 235 with reverse flow capabilities

With reference to FIG. 12, a nonlimiting embodiment of the present invention is illustrated, with a plurality of reactor vessels 202a, 202b, 202c . . . 202n equipped with catalyst beds 203 and heads 204 connected to shared inlet 201 and outlet 209 manifolds by piping 205 at each end of the vessels, with additional equipment to allow reverse flow through the reactor vessels. Reverse flow through the reactor vessels may be desirable for a number of reasons, including better heat exchange cycles, better product removal or more efficient catalyst use. Reverse flow requires a reversible reactor design as described by the present invention; one embodiment is described in detail in FIG. 15.

In comparison to FIG. 11 described above, the additional equipment includes additional manifolds 310, 311 connecting the inlet 201 and outlet 209 manifolds to both ends of the reactor vessels 202. In one embodiment, additional valves on the inlet 312, 313 and outlet 314, 315 manifolds determine the direction of flow through the reactors.

In a nonlimiting example of “forward flow”, valves 312 and 314 are open while valves 313 and 315 are closed; to fill individual reactor 202a reactant gasses flow from the inlet manifold 201 via manifold 311 through valve 206 pushing reacted product gasses out through valve 207 towards the outlet manifold 209 via manifold 310.

In a nonlimiting example of “reverse flow”, valves 312 and 314 are closed while valves 313 and 315 are open; to fill individual reactor 202a reactant gasses flow from the inlet manifold 201 via manifold 310 through valve 207 pushing reacted product gasses out through valve 206 towards the outlet manifold 209 via manifold 311.

The forward and reverse configurations described above can be used to fill all reactors in the system in the same manner. During changes in system configuration (eg. from forward to reverse flow or vice versa) overlaps between closure of valves 314 and 315 may be necessary to prevent reactor system bypass.

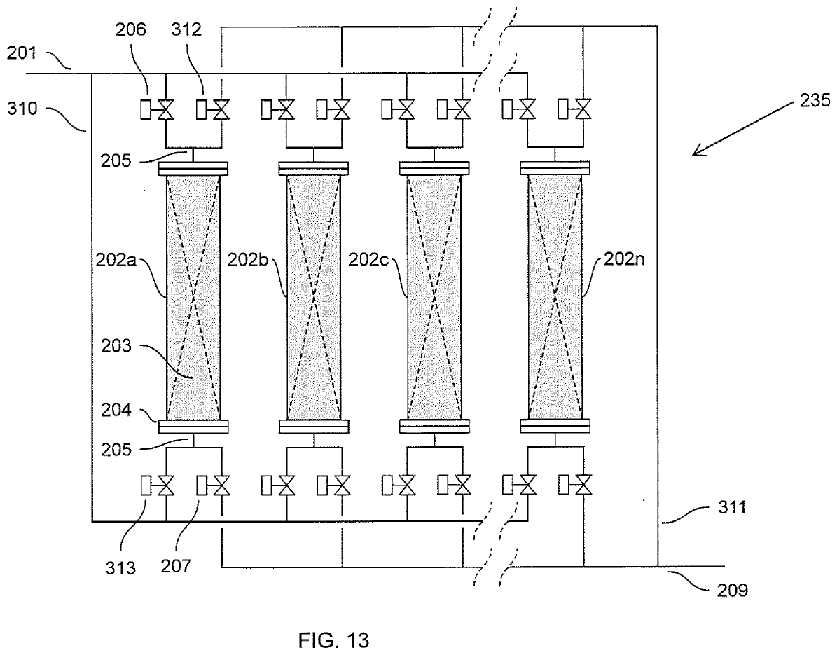

FIG. 13 illustrates a nonlimiting embodiment of a multi-vessel pseudo-batch reactor system 235 with concurrent reverse flow capabilities for individual reactors.

With reference to FIG. 13, an embodiment of the present invention is illustrated, with a plurality of reactor vessels 202a, 202b, 202c . . . 202n equipped with catalyst beds 203 and heads 204 are connected to shared inlet 201 and outlet 209 manifolds by piping 205 at each end of the vessels, with additional equipment to allow selectable reverse flow through the individual reactor vessels. An advantage of the nonlimiting embodiment shown in FIG. 13 over that shown in FIG. 12 is that individual reactors can be selected for reverse flow at any time without needing to reverse the flow within the shared pipes or manifolds. Reverse flow through the reactor vessels may be desirable for a number of reasons, including better heat exchange cycles, better reactant mixing, better product removal or more efficient catalyst use.

The additional equipment includes additional manifolds 310, 311 connecting the inlet 201 and outlet 209 manifolds to both ends of the reactor vessels. Additional valves 312, 313 on each reactor connect both ends of each reactor to both the inlet and outlet shared pipes or manifolds. In an nonlimiting example to fill individual reactor 202a reactant gasses flow via manifold 201 through valve 206 pushing reacted product gasses out through valve 207 towards outlet manifold 209. Once all the other reactors 202b, 202c . . . 202n are filled, reactor 202a can be refilled/emptied in reverse flow; by opening valve 313 and valve 312 new reactant fluid enters from manifold 310, pushing reacted product gasses out through valve 312 via manifold 311 towards the outlet manifold 209.

FIG. 14 illustrates a nonlimiting embodiment of the present invention: a multi-vessel pseudo-batch reactor system 235 with individually selectable reverse flow capabilities using multiport valves.

With reference to FIG. 14, a nonlimiting embodiment of the present invention is illustrated, with a plurality of reactor vessels 202a, 202b, 202c . . . 202n equipped with catalyst beds 203 and heads 204 are connected to shared inlet 201 and outlet 209 manifolds by piping 205 at each end of the vessels, using multi-port valves to allow selectable reverse flow through the individual reactor vessels. An advantage of the nonlimiting embodiment shown in FIG. 14 over that shown in FIG. 13 is that individual reactors can be selected for reverse flow at any time while still using a single valve or mechanism at the end of each reactor for the purpose.

In a nonlimiting example to fill individual reactor 202a reactant gasses flow via manifold 201 through valve 206 which is positioned to connect the inlet manifold reactor line 201 to the reactor via inlet piping 506; in this position the connection between line 506 and outlet manifold 311 is closed. The incoming gasses push any product gasses out through line 505 to valve 207 which is open towards outlet manifold 209 and closed towards inlet manifold 310. Once all the other reactors 202b, 2020 . . . 202n are filled reactor 202a can be refilled/emptied in reverse flow; by changing the position of valve 207 so that line 505 is open to the inlet manifold 310 and closed to the outlet manifold 209; similarly valve 206 is position so that line 506 is opened to the outlet manifold 311 and closed to the inlet manifold 201. New reactant fluid enters from manifold 310 via valve 207, pushing reacted product gasses out through valve 206 via manifold 511 towards the outlet manifold 209.

This nonlimiting embodiment of the present invention can also be used to have flow between reactors using the parallel manifolds. In an example scenario reactor 202a is emptied to reactor 202b via the outlet manifold. On reactor 202a, its valve 206a is positioned to connect the inlet manifold 201 to its line 506 while its valve 207a is positioned to connect its line 505 to the outlet manifold 209. Valve 314 is closed and valve 315 is open to the outlet 209. On reactor 502b, valve 206b is positioned to connect manifold 511 to its line 506; its valve 207b is positioned to connect its line 505 to manifold 209. Incoming gas flows from the inlet manifold 201 via piping 506a and valve 206a downwards through reactor 202a and to the manifold 209 via piping 505a and valve 207a. The gas then flows from line 509 to reactor 202b via its valve 207b and piping 505b upwards through reactor 202b and out to the outlet manifold 511 via its piping 506b and valve 206b. This process can be repeated and reversed on each filling cycle by alternating the open/closed positions of valves 512 and 513. In some nonlimiting embodiments of the present invention a single multiport valve may replace valves 512 and 513. In the nonlimiting embodiment described above a slight differential pressure between inlet and outlet manifolds may be required.

FIG. 15 illustrates a cross sectional view of a nonlimiting embodiment of an individual reactor pressure vessel used in the present invention and shown in FIGS. 11, FIG. 12, FIG. 13 and FIG. 14.

With reference to FIG. 15, in this nonlimiting embodiment a reactor 202 is made up of a cylindrical shell fitted with flanges 216 at each end to which heads 208 are attached. In one nonlimiting embodiment the heads 208 are removable and identical at each end. The heads are equipped with means 215 such as nozzles to connect piping for fluid entry and exit. The reactor 202 is filled with a catalyst bed 203 between the heads; the catalyst is prevented from exiting the pressure vessel during operation by catalyst holders 217 or grating at each end. In one nonlimiting embodiment the catalyst grating is located in between the flange 216 and heads 208; in another nonlimiting embodiment the grating may be integral to a gasket that creates a seal between the pressure vessel flanges and heads. To reduce cost and requirements of custom design, manufacture and testing, the reactor vessel may be constructed using a length of nominal pipe (NPS or DN) and the flanges and heads (605) are constructed using standard pipe flanges (eg. ASME, DIN or EN). The ability to use nominal pipe and standard flanges is enabled by the multi-vessel pseudo-batch reactor system described in the present invention.

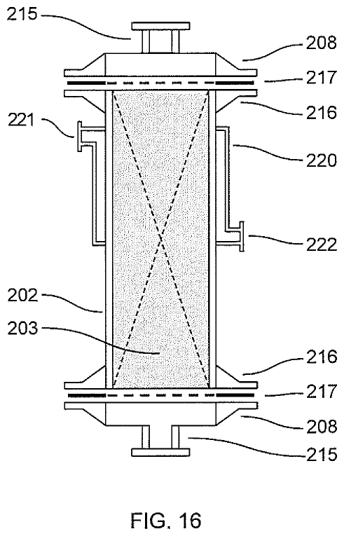

FIG. 16 illustrates a cross sectional view of a nonlimiting embodiment of an individual reactor pressure vessel used in the present invention with an active heat transfer system included.

With reference to FIG. 16, a nonlimiting embodiment of the individual reactor vessels used in the present invention is illustrated, similar to FIG. 15, with the addition of an active heat transfer system. As per FIG. 15, the reactor pressure vessel is made up of a cylindrical shell fitted with flanges 216 at each end to which heads 208 are attached. The heads of the pressure vessel are equipped with means 215 such as nozzles to connect piping for fluid entry and exit. The pressure vessel shell is filled with a catalyst bed 203 between the pressure vessel heads; the catalyst is prevented from exiting the pressure vessel during operation by catalyst holders 217 or grating at each end.

In one nonlimiting embodiment a hollow external pipe 220 equipped with inlet 221 and outlet 222 nozzles covers a portion of the cylindrical shell. Heat transfer medium flows via nozzle 221 into the external pipe 220 where it contacts the pressure vessel shell. In one nonlimiting embodiment used for reactor cooling, cool heat transfer medium is passed into the heat transfer system via nozzle 221 where it is heated, cooling the pressure vessel 202 and contents. The flow of the heat transfer medium can be controlled either continuously or by batch flow using a valve on the outlet (not shown here). In some embodiments, additional heat transfer medium can be used for thermal inertia during batch even if the medium doesn't flow during normal operation.

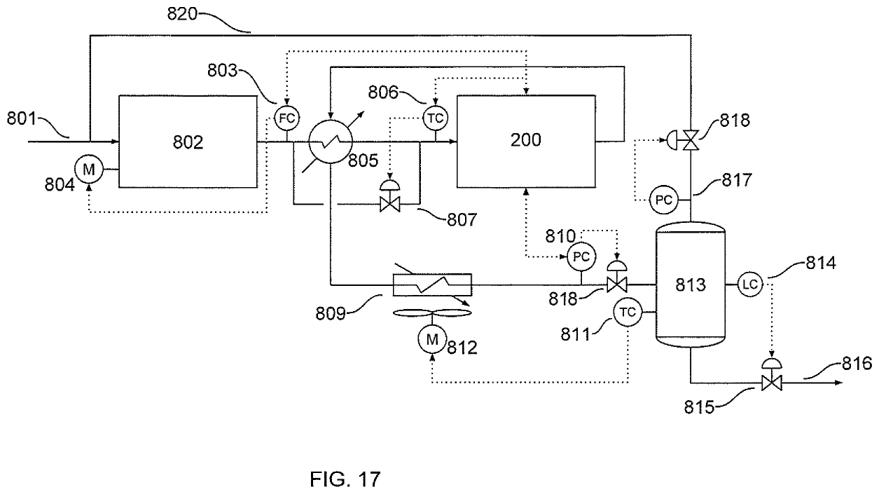

FIG. 17 is a process schematic of a nonlimiting example of an ammonia production system that illustrates how the present invention interacts with other parts of the system. As will be understood by the skilled artisan upon reading this disclosure, this process using a chemical reactor system of the present invention can be routinely adapted to gas synthesis processes other than ammonia in a similar manner.

With reference to FIG. 17, in this embodiment of an ammonia production system hydrogen and nitrogen feed gas are supplied to the system 801 and combined with recycled, unreacted feed gas 820 before being fed to a feed gas compressor system 802. In one embodiment the feed gas compressor 802 may be driven by a variable speed motor 804 and controlled by a flow controller 803 on the compressor outlet. Pressurized feed gasses pass through a feed gas heat exchanger 805 which uses hot gas exiting the reactor system 200 of the present invention to heat the feed gasses to a desired temperature. In one embodiment a temperature controller 806 controls a bypass 807 around the feed gas heat exchanger to optimize the temperature of feed gasses entering the reactor system 200; product gasses are further heated within the reactor system 200 of the present invention. Product and any unreacted feed gasses leaving the reactor system 235 are cooled in the feed gas heater exchanger 805 before being additionally cooled in a product gas cooler 809. In one nonlimiting embodiment this may be an air cooler driven by a variable drive motor 812 controlled by a downstream temperature controller 811. The pressure of the reactor system is controlled by a pressure controller 810 and control valve 818; in one nonlimiting embodiment this is located after the product gas cooler 809. Cooled product gasses are passed to a gas-liquid separator 813 where liquids are separated from unreacted hydrogen and nitrogen gasses. The level in the gas-liquid separator is controlled by a level controller 814 with a level control valve 815; liquid ammonia product leaves the system 816. The pressure of the product gas-liquid separator is controlled by a pressure controller 817 and control valve 818 with the separator operating conditions (pressure and temperature) set to ensure ammonia is liquid while any unreacted hydrogen and nitrogen are in gaseous state. Unreacted hydrogen and nitrogen gasses are recycled to the inlet feed gas compressor 820.

In this nonlimiting embodiment of an ammonia production system, the reactor system 200 receives data and controls setpoints of the feed gas compressor flow control 803, the feed gas heat exchanger bypass temperature controller 806 and the system pressure controller 810. As a nonlimiting example, the reactor system 200 may interact with the compressor flow controller 803 by increasing the compressor flow rate setpoint in order to decrease the batch residence time, or vice versa. Likewise the reactor system 200 may decrease feed gas heater temperature control setpoint to lower the feed gas inlet temperature as the system throughput decreases and batch residence times (and thus reaction conversion) increases.

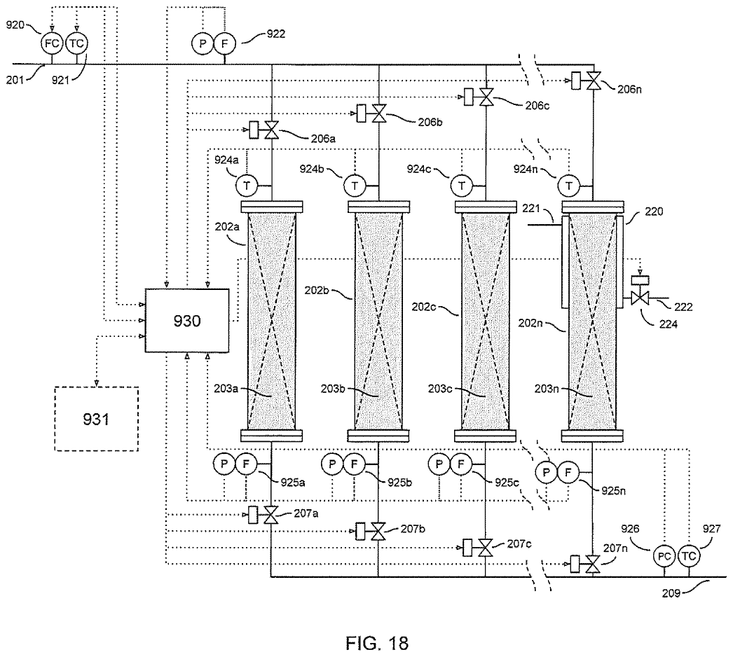

Further details of various embodiments of the present invention control systems are outlined in FIG. 18.

FIG. 18 is a process schematic of a nonlimiting embodiment of a control system for a chemical reactor system as depicted in FIG. 11 and described above.

With reference to FIG. 18, in this nonlimiting embodiment of an ammonia production system the flow of gas through a multi-vessel batch reactor comprising a plurality of pressure vessel reactors 202a-n equipped with catalyst beds 203a-n is controlled by a local system controller 930, using a series of inlet 206a-n and outlet 207a-n mechanisms and various sensors, with input from a remote controller 931.

During normal operation, pressurized synthesis feed gas is supplied to the inlet manifold 201. As described in FIG. 17 the flow rate and temperature of the fluids entering the system are set by upstream system controllers 920, 921 with input from the local system controller 930. The flow rate and pressure at the inlet manifold 201 is monitored via pressure/flow transmitters 922 to determine that flow into the system matches system capacity; an increase in inlet manifold pressure would inform the local controller 930 to lower the output flow rate set point of any upstream compression system.

As gas arrives and the pressure increases the local controller 930 opens the inlet and outlet valves 206a, 207a on the first reactor 202a causing gas to flow into that individual reactor, expelling any product gas to the outlet manifold 209. In one nonlimiting embodiment, the local controller 930 is equipped with the reactor 202a characteristics (such as gas space volume) and can measure reactor conditions such as inlet pressure 922 and temperature 921, outlet pressure 925, 926, reactor temperature 924, 927 and the flow of gas through the reactor; using this data it calculates the time required to fill the reactor with new synthesis gas.

The inlet and outlet valves 206a, 207a are programmed to close once the product gas is expelled; the valves start closing in order to be fully closed once the majority of product gas is expelled. In one embodiment a small amount of product gas may be kept in the system to prevent unreacted synthesis gas from escaping to the outlet manifold. As the valves are closing on the first reactor 202a the system starts opening the valves 206b, 207b on the second reactor 202b. The sequence repeats for reactors 202c and so on until the last reactor 202n is filled; this completes a single filling cycle. Once each cycle is completed the first reactor 202a is refilled/emptied using the same technique.

As each reactor is filled and subsequently closed to allow the exothermic reaction to progress, heat is released as ammonia is produced causing the temperature of the reactants, products, catalyst and reactor vessel to rise. Some nonlimiting embodiments of the reactor system may operate adiabatically, without significant or deliberate heat or material removal from the system during the reaction period. The local controller 930 monitors the reaction progression via temperature 924 and pressure 925 measurements; some nonlimiting embodiments of the present invention may have more than a single temperature indicator to ensure accurate monitoring of the entire reactor length. Once the reaction has progressed to the desired point the reactor is refilled using the same sequence as described above, flushing the hot reactor contents towards the outlet manifold 209.

The temperature of the catalyst and reactor body is lowered during the refilling process by the incoming cooler feed gas; the incoming synthesis gas is heated as it enters the reactor. The local controller 930 ensures the inlet manifold gas temperature controller 921 setpoint is low enough so that the heating of the reactor during the batch reaction is adequately offset by sufficient cooling during each filling cycle. In parallel, the local controller 930 sets the residence time of the reactors to ensure that the highest temperature reached in the reactors doesn't keep increasing over time. In some nonlimiting embodiments of the system, if reactor temperature increases over time, the local controller 930 can increase the overall flow rate 920 through the system to lower the residence time (and thus reaction conversion and heat released) in each reactor cycle. Another method the local controller 930 can employ to lower or increase the residence time is to use fewer or more reactors in a given filling cycle.

To allow for varied performance of catalysts including different catalyst materials, sizes, shapes and ages, as well as different reactor sizes, some embodiments of the reactor system may allow parallel reactor batch cycles with various residence times and filling rates. This ensures that once a given reactor maximum temperature is reached there is no need for the local controller 930 to wait for the full cycle of reactors to fill in series before refilling a reactor that is approaching its temperature limit.

Some nonlimiting embodiments of the system may have additional heat transfer mechanisms as illustrated on one vessel 202n, such as a hollow outer pipe 220 or a sleeve or jacket on the reactor that is filled with heat transfer fluid connected to a cooling or heating loop that enables active reactor temperature control. The heat transfer jacket has inlet piping 221, outlet piping 222 and valving 224 to control the flow of heat transfer medium. In some embodiments of the reactor system all reactors are equipped with this active cooling mechanism; in other embodiments only a portion of reactors are equipped with active cooling. The active cooling system may also be used for reactor heating during system start-up. To operate the reactor heat transfer system, the local controller 930 opens the heat transfer medium control valve 224 to ensure heat transfer medium flows at a sufficient rate to keep the reactor temperature constant (isothermal operation); the local controller 930 may set the active heat transfer system to cool the reactor or slow the reactor temperature increase once a given temperature has been reached. This allows the equilibrium conversion to be increased beyond pure adiabatic operation which would require the expulsion of the reactor contents at a given temperature to maintain reactor and catalyst temperature below a certain value.

Some nonlimiting embodiments of the system may include connection of the local controller 930 to a remote controller 931 that receives data from and sends data to a number of systems operating in parallel. In some embodiments the remote controller may be cloud based. The remote controller 931 can be used to collect data from non-system specific sources, such as weather tracking systems or databases, performance data of other reactor systems operating nearby or local renewable energy power demand curves and use these inputs to make predictions of required reactor system performance conditions or setpoints. Some embodiments of the system may make use of artificial intelligence within or by the remote controller 931 to help generate predictive control setpoints for the local controller 930; other embodiments may use the remote controller for centralized compute power to enable lower cost local controllers.

The use of some forms of batch reactors and batch reactors in parallel has been used previously in wastewater systems, bioreactors and laboratory testing; however no system has yet been designed to allow batch reactors to be used for either production scale gas phase catalyst reactions with solid catalysts, fixed bed reactors or high pressure gas systems as is the requirement for industrial level ammonia synthesis. The current speed, precision and level of predictive computerized automation, required for reliable output and safe system operation, facilitates new approaches to reactor design, arrangement and automated process control as described by the present invention.

The chemical reactor systems of the present invention provide multiple advantages for gas synthesis.

For example, reactants can be added to the reactor separately, at controlled rates, to allow control of the reaction rate, the reactor temperature to suit the time available when powered with intermittent renewable energy. The use of batch reactors in accordance with this embodiment allows hydrogen to be “stored” within the reactor at high pressure until a suitable time for ammonia production; one nonlimiting example of this is hydrogen production and high pressure storage within the reactors during the day with ammonia production after periods of peak renewable power.

The ability to add reactants separately also enables the use of different than ammonia reaction standard 3:1 stoichiometric ratios in order to increase the equilibrium conversion according to Le Chatelier's principle. The ability to remove liquid product without the unreacted feed gas allows the use of stoichiometrically incorrect feed gas ratios without the penalty of increased compression due to high recycle rates.

Further, each reactor in the system can be a pressure vessel, containing a catalyst suitable for gas synthesis such as ammonia. In one nonlimiting embodiment each reactor vessel consists of a standard hydrogen storage tank containing a catalyst and equipped with an opening at one end. Within a complete system, each individual packed bed reactor is connected to shared inlet and outlet manifolds and equipped with one or more mechanisms to control the entry of reactants from the inlet manifold and exit of reaction products to the outlet manifold; in a preferred embodiment, the mechanisms are automated to enable individual control of conditions within a single reactor but in coordination and unison with all reactors across the system. Opening and closing the mechanisms in the correct sequence across the plurality of the reactors allows individual vessels to operate as batch reactors, with a controllable residence time or GHSV, while the overall system of reactors operates with a stable and continuous throughput. More specifically, the operation of catalytic reactors as batch reactors allows for “non-moving”, “stationary”, “non-flowing” or “static” residence time of reactants and products within the catalyst bed; for a given reactor vessel in the present invention this is the time between bulk filling and emptying. During the period when the inlet and outlet mechanisms are closed the reactant gasses are allowed to distribute themselves throughout the reactor without being pushed forward along the reactor axis (towards the outlet) as is the case with plug flow or other steady state reactors. The technology described herein is known as “static gas catalysis” or “non-flowing gas catalysis” and allows the catalytic reaction to be more evenly distributed throughout the catalyst bed without the need for internal fluid inlet distribution mechanisms or large gas volumes at the reactor inlet; it also allows the reaction and any heat released or absorbed to be spread across the full volume of the catalyst bed.

For a system where all reactors are filled one after the other in series, the non-moving batch or “static” residence time of each reactor vessel is approximately equal to the individual reactor fill time multiplied by the number of subsequent reactors in the system. For a given desired maximum residence time a “cycle” would be defined as the process of filling all reactors in a given series of reactors then returning to refill/empty the first reactor.

At the start of a batch sequence each reactor has an internal pressure lower than the pressure in the inlet manifolds; as reactants enter the reactor from the inlet manifold the reactor internal pressure increases. Once the desired reaction pressure is reached and enough reactants have been added to the reactor vessel, the entry mechanism is closed to allow the reaction to progress.

In some nonlimiting embodiments of the present invention, the ratio of the reactants entering the vessel are modified to control the reaction progression and heat released through the reactor vessel wall. One nonlimiting example of this is to first fill the vessel to a desired pressure with hot, compressed hydrogen only then add nitrogen sufficiently gradually such that the heat generated by the exothermic reaction matches the heat released to the atmosphere through the reactor wall. In this embodiment the reaction temperature is held constant by controlling the amount of ammonia produced and thus exothermic reaction heat released by controlling the entry of nitrogen to match the heat released from the reactor to the atmosphere. An additional advantage of this embodiment of the present invention is the use of Le Chatelier's principle whereby a high (or excess) concentration of reactants will push the reaction towards the product side, resulting in a higher equilibrium conversion for a given operating temperature and pressure.

When the reaction has progressed to a desired point the reactant entry mechanisms are closed which stops the reaction inside the reactor vessel and the exothermic reaction heat released and the vessel will begin to cool. Once the reactor and its contents have cooled below the ammonia product critical temperature, the gaseous product will turn to liquid. The vessel can then be emptied of liquid product by opening the mechanism connecting the reactor to the outlet manifold and allowing product liquids to leave the pressure vessel. As the liquid product is emptied from the vessel, the internal pressure drops, which allows the reactor to be refilled with reactant gasses once sufficient product has been discharged.

Depending on the reaction residence time available some embodiments of the present invention may actively modify the operating conditions of temperature, pressure and reactant ratio within the reactor to optimize conversion, energy use or other factors such that the reaction progression matches the time available. A nonlimiting example of this is to lower the operating temperature to ensure a slower, more controlled reaction rate with higher equilibrium conversion. Another nonlimiting example is to lower the operating pressure to reduce compression energy requirements while also lowering reaction temperature or modifying stoichiometric reactant ratios to counteract the equilibrium conversion loss of a lower reaction pressure.

The filling and emptying rates of individual reactors within the system is limited to a maximum defined by pressure drop, catalyst entrainment, catalyst damage or some other physical criteria. It is not possible to add an infinite number of batch reactors into the same cycle while maintaining the same target filling time; this would require reducing the fill time of individual reactors towards 0 seconds for each reactor. Beyond a certain fill rate into individual reactors, multiple reactor parallel fill (i.e. filling groups of reactors at the same time) will be required. The present invention thus allows groups of reactors to be filled in parallel to limit the individual reactor fill rate and even allows the entire system to operate with reactants entering and exiting the reactors in some form of continuous parallel flow, such as staggered overlapped parallel filling, as required for best system performance.

In the case of parallel or pseudo-parallel continuous flow the use of external mechanisms, manifolding and associated control systems described in the present invention can ensure optimum and regulated distribution of reactant gasses across the plurality of reactors.

The individual reactors and overall reactor system in the present invention are also designed such that by using automated entry mechanisms each reactor can also operate in a “pseudo-batch” mode wherein the reactor can be partially filled, refilled/repressurized mid-reaction, operate at independent temperatures and pressures or filled with varying compositions of reactants, potentially optimizing reaction rate and equilibrium conversion.

Some embodiments of the present invention allow advanced control systems to achieve different residence times for either individual or groups of reactors; achieved by either different ordering of series filled or parallel filled reactors. This feature of the present invention allows different catalyst materials, sizing or shapes to be used within individual reactors or groups of reactors, which may require different fluid residence times; it is also useful for dynamic operational states such as cold reactor start-up or varied reactor operating temperatures and pressures.

The use of external mechanisms to allow individual reactors operating in batch (or pseudo-batch) mode allows the designing engineer to decouple the individual reactor dimensional constraints from the target residence time or GHSV. The use of batch mode with catalytic reactors allows a high residence time without the need to increase the reactor length significantly or be concerned with radial fluid distribution or plug flow deviations. This meets the ability to size the reactor to fit into small spaces while still achieving a large residence time without the need for complicated internal gas distribution systems, large entry volumes and excessive pressure drop over long catalyst bed lengths.

The use of correctly designed catalytic reactors operating in batch (or pseudo-batch) mode overcomes the disadvantages of using plug flow reactor vessels at high turndown (low overall system throughput) where the current state-of-the-art encounters problems with poor distribution of reactants, channeling, catalyst hot spots and inefficient catalyst use at rates far below the peak design operating point.

A further advantage of the present invention is that it simplifies reactor temperature control by distributing the reaction (and thus any heat released or absorbed) across the entire catalyst bed and reactor body, avoiding catalyst hot spots and sintering. A higher reactor metal-to-catalyst weight ratio in this case becomes an advantage with respect to thermal inertia of the system, preventing excessive heating of the fluids and catalyst.

A further advantage of the present invention, particularly for use within a green ammonia production system coupled to intermittent renewable power sources, is that due to batch or pseudo-batch operation, the system performance (including equilibrium conversion) actually increases as the overall system throughput reduces (ie a higher turndown ratio) due to the increase of the controlled residence time within each reactor vessel; this is the opposite for current state-of-the-art plug flow reactor designs.

A further advantage of some embodiments of the present invention, is that the use of long duration batch reactors allows cooling of the ammonia produced down to below the critical temperature at high pressure which allows gas reactant separation from ammonia liquids without the need for significant pressure drop or large heat exchangers to cool the ammonia product.

A further advantage of some embodiments of the present invention, the production of ammonia can occur during periods where no renewable energy is available, such as overnight or when there is no wind or sun. In some embodiments, reactor vessels can be filled during the day, left to produce ammonia overnight and emptied the next morning. In this example of the present invention hydrogen is produced and compressed into the empty or partially empty reactor vessels and nitrogen is produced and stored at high pressure in separate storage tanks during periods when energy is available. Once the reactor vessels are full (or no more intermittent energy is available, whichever comes first) the reaction is started in the hydrogen filled reactor vessels by slowly adding nitrogen as described above. The small amount of power required for control can be either provided by batteries, operating the electrolysis cells in reverse (using a portion of the hydrogen compressed previously) or using stored compressed nitrogen for pneumatic controls.

A further advantage of the present invention for the production of green ammonia using electricity from intermittent renewable energy sources is that the operational conditions (pressure and temperature) can be varied to allow the batch reaction to progress at slow rates to optimise reaction conversion and overall energy use.

Further, while the use of multiple smaller reactors with external gas distribution mechanisms increases the metal/catalyst weight or volume ratio (a high ratio is a proxy for higher overall system fabrication cost), the use of the highly simplified reactors described by the present invention, particularly when constructed from standardized parts as described herein, makes the overall system cost competitive. In parallel, the present invention allows system designers to take advantage of reactor modularity with respect to both throughput and residence time without having to custom design each reactor vessel. This allows both engineering and fabrication costs to be amortized across multiple facilities, lowering the average price of each individual system.

### EMBODIMENTS

An embodiment of the present invention relates to a chemical reactor system for gas synthesis, said system comprising a batch, pseudo-batch or dynamic reactor of one or more individual catalytic reactors for gas synthesis; one or more fluid control mechanisms of shared pipe and manifolds for delivery of reactants to and collection of reaction product from the chemical reactor system; and a control system capable of opening the one or more fluid control mechanisms to control entry of reactants to and exit of reaction products from the chemical reactor system.

In the above preceding embodiment, the batch, pseudo-batch or dynamic reactor may be a temperature swing gas synthesis reactor.

In any of the above preceding embodiments, the one or more individual catalytic reactors may comprise a single means located at one end to allow fluids to enter and exit the individual reactor and contact the catalyst.

In any of the above preceding embodiments, each individual catalytic reactor may have a separate entry and exit means to allow fluids to enter and exit the individual reactor and contact the catalyst.

In any of the above preceding embodiments, the control system may capable of controlling reactor entry and exit mechanisms in the system via the one or more fluid control mechanisms to facilitate fluid flow in series, parallel or a combination thereof through the individual catalytic reactors such that fluid flow through the chemical reactor system is close to continuous, while fluid in each individual catalytic reactor is stationary or close to stationary for a portion of its residence time.

In any of the above preceding embodiments, each individual catalytic reactor may comprise a cylindrical shell pressure vessel having a pressure vessel head at each end; a catalyst bed between the pressure vessel heads; a catalyst holder positioned within at least one of the pressure vessel heads that prevents catalyst from exiting the vessel during operation; and a means to allow fluids to enter and exit the pressure vessel and contact the catalyst.

In any of the above preceding embodiments, a portion of one or more individual catalytic reactors may be used to store hydrogen, nitrogen, ammonia or other gasses.

In any of the preceding embodiments, the batch, pseudo-batch or dynamic reactor may comprise a plurality of individual catalytic reactors for gas synthesis, and additional mechanisms fitted to the shared pipes or manifolds connecting the individual catalytic reactors to enable reverse flow into individual or groups of individual catalytic reactors while simultaneously allowing forward flow into other individual catalytic reactors in the same reactor system.

In any of the above preceding embodiments, the control system may be automated and/or capable of operating individual or groups of catalytic reactors in batch operating mode.

In any of the above preceding embodiments, the control system may be automated and/or capable of operating individual or groups of catalytic reactors in continuous, steady state or plug flow operating mode.

In any of the above preceding embodiments, one or more of the individual catalytic reactors may be equipped with internal and/or external heat transfer systems to modify the temperature of the reactor as the reaction progresses.

In any of the above preceding embodiments, one or more of the individual catalytic reactors may be designed as a pipe-in-pipe heat exchangers.

In any of the above preceding embodiments, the control system may be computerized and connected to a remote or cloud based controller.

In any of the above preceding embodiments, the control system may use algorithms, artificial intelligence or machine learning to optimize performance of the individual or group of catalytic reactors vessels and the chemical reactor system.

In any of the above preceding embodiments, one or more of the individual catalytic reactors may be equipped with a sensor, detector or controller that passes information to the control system so that the chemical reactor system operates in a manner that allows continuous inlet flow of reactants and outlet flow of reaction products through the chemical reactor system.

In any of the above preceding embodiments, the gas synthesis may be ammonia synthesis.

Another embodiment of the present invention relates to an energy waste reduction system comprising any of the above preceding embodiments of chemical reactor systems coupled to a variable or intermittent energy production technology.

Another embodiment of the present invention relates to methods for producing a gas via a variable or intermittent energy production technology via any of the above preceding embodiments of chemical reactor systems.

Another embodiment of the present invention relates to a method for producing a gas via the steps of: supplying synthesis feed gas to a chemical reactor system of any of the above preceding embodiments of chemical reactor systems; opening the one or more fluid control mechanisms of an individual catalytic reactor or group of reactors to enable sufficient synthesis feed gas to pass into each reactor such that it is filled with the feed gas; closing the one or more fluid control mechanisms once filled with feed gas to stop or sufficiently slow flow of gas in contact with the catalyst to allow the reaction to take place; timing, predicting and/or monitoring temperature, pressure and/or other measurable states within each closed or partially closed reactor to determine reaction progression; and expelling a reaction product once the reaction has reached the desired reaction progress.

Another embodiment of the present invention relates to a method for retrofitting an ammonia plant having a synthesis loop wherein fresh ammonia synthesis gas containing hydrogen and nitrogen is combined with any recycle streams to form a combined ammonia synthesis gas and the combined ammonia synthesis gas is reacted over a catalyst to form a converted ammonia product gas, said retrofitting method comprising the steps of: replacing an existing ammonia synthesis reactor or reactors with a chemical reactor system of any of the above preceding embodiments of chemical reactor systems having a control system capable of: (i) manipulating one or more batch, pseudo-batch or dynamic reactors and their fluid control mechanisms such that they are filled with synthesis gas in sequence to allow batch or close to batch residence time in each reactor while having a continuous or close to continuous flow of feed gas through the entire system of reactor vessels; (ii) controlling the synthesis feed gas temperature; and (iii) controlling the reactor system operating pressure; installing feed gas heat exchangers capable of heating a synthesis gas to a targeted and controlled temperature as required for reactor batch operation upstream of the chemical reactor system; installing heat exchangers and a vapor-liquid separator for condensing and recovering ammonia from the reactor effluent stream and forming an ammonia-lean stream; and installing a pressure control system to enable operating pressure of the chemical reactor system to be controlled and manipulated.

Another embodiment of the present invention relates to a method for producing ammonia from synthesis gas containing hydrogen and nitrogen combined with any recycle streams via the steps of: (a) supplying synthesis feed gas to a system comprising one or more catalyst filled pressure vessel reactors, each catalyst filled pressure vessel reactor being connected to one or more manifolds at the inlet and one or more manifolds at the outlet of the system, each catalyst filled pressure vessel reactor being equipped with an independently operated mechanism to control, direct and stop the flow of fluids to or from the individual vessel and catalyst bed via said inlet and outlet manifolds; opening the control mechanism of a selected catalyst filled pressure vessel reactor or group of catalyst filled pressure vessel reactors to enable sufficient synthesis feed gas to pass into each catalyst filled pressure vessel reactor from its inlet manifold such that it is filled with the feed gas and pressurized to a selected operating pressure; closing the control mechanisms at each end of the selected catalyst filled pressure vessel reactor or group of reactors once filled with feed gas to stop or sufficiently slow the flow of gas in contact with the catalyst to allow the reaction to take place; timing, predicting or monitoring temperature, pressure or other measurable states within each closed or partially closed catalyst filled pressure vessel reactor to determine the reaction progression; allowing the catalyst filled pressure vessel reactor or reactors to cool below the ammonia product critical point or dew point temperature once the reaction has reached a desired state, conversion or equilibrium conversion; expelling liquid ammonia product that collects at the lower portion of the catalyst filled pressure vessel reactor or reactors once sufficiently cooled, without allowing the majority of unreacted gasses to escape the catalyst filled pressure vessel reactor or reactors; and repeating the filling process by adding new synthesis feed gas to any unreacted gasses remaining in the catalyst filled pressure vessel reactor or reactors.

In the above preceding method embodiment, one or more reactants may be introduced sufficiently gradually to each catalyst filled pressure vessel reactor to allow controlled ammonia production and temperature release to maintain desired operating temperature and pressure operating conditions within the individual catalyst filled pressure vessel reactor.

In any of the above preceding method embodiments, one or more of the catalyst filled reactor vessels can be used to store reactants at high pressure prior to introduction of a second reactant to start the ammonia production process in a controlled manner.

In any of the above preceding method embodiments, the hydrogen and/or nitrogen may be stored in the one or more catalyst filled pressure vessel reactors at sufficiently high pressure during periods when power is available so that they can be transferred to a portion of said one or more catalyst filled pressure vessel reactors to produce ammonia during periods when power is not available.

In any of the above preceding method embodiments, the one or more catalyst filled pressure vessel reactors may be filled with feed gas in sequence to allow batch or close to batch residence time in each reactor while having a continuous or close to continuous flow of feed gas through the entire system of reactor vessels.

In any of the above preceding method embodiments, the one or more catalyst filled pressure vessel reactors may be equipped with sensors, detectors or controllers that pass information to a control system or systems such that the system of reactors, mechanisms, sensors and control system is able to operate in a manner that allows continuous inlet flow of feed gas and outlet flow of products through the overall system of reactors.

In any of the above preceding method embodiments, the one or more catalyst filled pressure vessel reactors may be equipped with a control system capable of manipulating the reactors and their fluid control mechanisms such that they are filled with synthesis gas in sequence to allow batch or close to batch residence time in each reactor while having a continuous or close to continuous flow of feed gas through the entire system of reactor vessels.

In any of the above preceding method embodiments, the one or more catalyst filled pressure vessel reactors may be equipped with a control system capable of controlling the synthesis feed gas temperature.

In any of the above preceding method embodiments, the one or more catalyst filled pressure vessel reactors may be equipped with a control system capable of controlling the reactor system operating pressure.

In any of the above preceding method embodiments, the one or more catalyst filled pressure vessel reactors may be equipped with an internal or external heat transfer system to modify the temperature of the reactor as the reaction progresses.

In any of the above preceding method embodiments, one or more of the catalyst filled pressure vessel reactors may be designed as pipe-in-pipe heat exchangers.

1. A chemical reactor system for gas synthesis, said system comprising:
a batch, pseudo-batch or dynamic reactor of one or more individual catalytic reactors for gas synthesis;
one or more fluid control mechanisms of shared pipe and manifolds for delivery of reactants to and collection of reaction product from the chemical reactor system; and
a control system capable of opening the one or more fluid control mechanisms to control entry of reactants to and exit of reaction products from the chemical reactor system.

2. The chemical reactor system of claim 1 wherein the batch, pseudo-batch or dynamic reactor is a temperature swing gas synthesis reactor.

3. The chemical reactor system of claim 2 wherein one or more individual catalytic reactors has a single means located at one end to allow fluids to enter and exit the individual reactor and contact the catalyst.

4. The chemical reactor system of claim 1 wherein each individual catalytic reactor has a separate entry and exit means to allow fluids to enter and exit the individual reactor and contact the catalyst.

5. The chemical reactor system of claim 1 comprising a batch, pseudo-batch or dynamic reactor with a plurality of individual catalytic reactors for gas synthesis, wherein the control system is capable of controlling reactor entry and exit mechanisms in the system via the one or more fluid control mechanisms to facilitate fluid flow in series, parallel or a combination thereof through the individual catalytic reactors such that fluid flow through the chemical reactor system is close to continuous, while fluid in each individual catalytic reactor is stationary or close to stationary for a portion of its residence time.

6. The chemical reactor system of claim 1 wherein each individual catalytic reactor comprises:
a cylindrical shell pressure vessel having a pressure vessel head at each end;
a catalyst bed between the pressure vessel heads;
a catalyst holder positioned within at least one of the pressure vessel heads that prevents catalyst from exiting the vessel during operation; and
a means to allow fluids to enter and exit the pressure vessel and contact the catalyst.

7. The chemical reactor system of claim 1, wherein a portion of one or more individual catalytic reactors is used to store hydrogen, nitrogen, ammonia or other gasses.

8. The chemical reactor system of claim 1 comprising a batch, pseudo-batch or dynamic reactor with a plurality of individual catalytic reactors for gas synthesis, and additional mechanisms fitted to the shared pipes or manifolds connecting the individual catalytic reactors to enable reverse flow into individual or groups of individual catalytic reactors while simultaneously allowing forward flow into other individual catalytic reactors in the same reactor system.

9. The chemical reactor system of claim 1, wherein the control system is automated and is capable of operating individual or groups of catalytic reactors in batch operating mode.

10. The chemical reactor system of claim 1, wherein the control system is automated and is capable of operating individual or groups of catalytic reactors in continuous, steady state or plug flow operating mode.

11. The chemical reactor system of claim 1, wherein one or more of the individual catalytic reactors is equipped with internal or external heat transfer systems to modify the temperature of the reactor as the reaction progresses.

12. The chemical reactor system of claim 1, wherein one or more of the individual catalytic reactors are designed as a pipe-in-pipe heat exchangers.

13. The chemical reactor system of claim 1, wherein the control system is computerized and connected to a remote or cloud based controller.

14. The chemical reactor system of claim 1, wherein the control system uses algorithms, artificial intelligence, predictive control or machine learning to optimize performance of the individual or group of catalytic reactors vessels and the chemical reactor system.

15. The chemical reactor system of claim 1 wherein one or more of the individual catalytic reactors is equipped with a sensor, detector or controller that passes information to the control system so that the chemical reactor system operates in a manner that allows continuous inlet flow of reactants and outlet flow of reaction products through the chemical reactor system.

16. The chemical reactor system of claim 1 wherein the gas synthesis is ammonia synthesis.

17. An energy waste reduction system comprising the chemical reactor system of claim 1 coupled to a variable or intermittent energy production technology.

18. A method for producing a gas via an intermittent energy production technology, said method comprising coupling the intermittent energy production technology to the chemical reactor system of claim 1.

19. A method for producing a gas, the method comprising the steps of:
supplying synthesis feed gas to the chemical reactor system of claim 1;
opening the one or more fluid control mechanisms of an individual catalytic reactor or group of reactors to enable sufficient synthesis feed gas to pass into each reactor such that it is filled with the feed gas;
closing the one or more fluid control mechanisms once filled with feed gas to stop or sufficiently slow flow of gas in contact with the catalyst to allow the reaction to take place;
timing, predicting and/or monitoring temperature, pressure and/or other measurable states within each closed or partially closed reactor to determine reaction progression; and
expelling a reaction product once the reaction has reached the desired reaction progress.

20. A method for retrofitting an ammonia plant having a synthesis loop wherein fresh ammonia synthesis gas containing hydrogen and nitrogen is combined with any recycle streams to form a combined ammonia synthesis gas and the combined ammonia synthesis gas is reacted over a catalyst to form a converted ammonia product gas, said retrofitting method comprising the steps of:
replacing an existing ammonia synthesis reactor or reactors with the chemical reactor system of claim 16 having a control system capable of:
(i) manipulating one or more batch, pseudo-batch or dynamic reactors and their fluid control mechanisms such that they are filled with synthesis gas in sequence to allow batch or close to batch residence time in each reactor while having a continuous or close to continuous flow of feed gas through the entire system of reactor vessels;
(ii) controlling the synthesis feed gas temperature; and
(iii) controlling the reactor system operating pressure;
installing feed gas heat exchangers capable of heating a synthesis gas to a targeted and controlled temperature as required for reactor batch operation upstream of the chemical reactor system;
installing heat exchangers and a vapor-liquid separator for condensing and recovering ammonia from the reactor effluent stream and forming an ammonia-lean stream; and
installing a pressure control system to enable operating pressure of the chemical reactor system to be controlled and manipulated.

21. A method for producing ammonia from synthesis gas containing hydrogen and nitrogen combined with any recycle streams, the process comprising the steps of:
(a) supplying synthesis feed gas to a system comprising one or more catalyst filled pressure vessel reactors, each catalyst filled pressure vessel reactor being connected to one or more manifolds at the inlet and one or more manifolds at the outlet of the system, each catalyst filled pressure vessel reactor being equipped with an independently operated mechanism to control, direct and stop the flow of fluids to or from the individual vessel and catalyst bed via said inlet and outlet manifolds;
(b) opening the control mechanism of a selected catalyst filled pressure vessel reactor or group of catalyst filled pressure vessel reactors to enable sufficient synthesis feed gas to pass into each catalyst filled pressure vessel reactor from its inlet manifold such that it is filled with the feed gas and pressurized to a selected operating pressure;
(c) closing the control mechanisms at each end of the selected catalyst filled pressure vessel reactor or group of reactors once filled with feed gas to stop or sufficiently slow the flow of gas in contact with the catalyst to allow the reaction to take place;
(d) timing, predicting or monitoring temperature, pressure or other measurable states within each closed or partially closed catalyst filled pressure vessel reactor to determine the reaction progression;
(e) allowing the catalyst filled pressure vessel reactor or reactors to cool below the ammonia product critical point or dew point temperature once the reaction has reached a desired state, conversion or equilibrium conversion;
(f) expelling liquid ammonia product that collects at the lower portion of the catalyst filled pressure vessel reactor or reactors once sufficiently cooled, without allowing the majority of unreacted gasses to escape the catalyst filled pressure vessel reactor or reactors; and
(g) repeating the filling process by adding new synthesis feed gas to any unreacted gasses remaining in the catalyst filled pressure vessel reactor or reactors.

22. The method of claim 21, wherein one or more reactants is introduced sufficiently gradually to each catalyst filled pressure vessel reactor to allow controlled ammonia production and temperature release to maintain desired operating temperature and pressure operating conditions within the individual catalyst filled pressure vessel reactor.

23. The method of claim 21, wherein one or more of the catalyst filled reactor vessels are used to store reactants at high pressure prior to introduction of a second reactant to start the ammonia production process in a controlled manner.

24. The method of claim 21, wherein the hydrogen and nitrogen are stored in the one or more catalyst filled pressure vessel reactors at sufficiently high pressure during periods when power is available so that they can be transferred to a portion of said one or more catalyst filled pressure vessel reactors to produce ammonia during periods when power is not available.

25. The method of claim 21, wherein the one or more catalyst filled pressure vessel reactors is filled with feed gas in sequence to allow batch or close to batch residence time in each reactor while having a continuous or close to continuous flow of feed gas through the entire system of reactor vessels.

26. The method of claim 21, wherein the one or more catalyst filled pressure vessel reactors is equipped with sensors, detectors or controllers that pass information to a control system or systems such that the system of reactors, mechanisms, sensors and control system is able to operate in a manner that allows continuous inlet flow of feed gas and outlet flow of products through the overall system of reactors.

27. The method of claim 21, wherein the one or more catalyst filled pressure vessel reactors is equipped with a control system capable of manipulating the reactors and their fluid control mechanisms such that they are filled with synthesis gas in sequence to allow batch or close to batch residence time in each reactor while having a continuous or close to continuous flow of feed gas through the entire system of reactor vessels.

28. The method of claim 21, wherein the one or more catalyst filled pressure vessel reactors is equipped with a control system capable of controlling the synthesis feed gas temperature.

29. The method of claim 21, wherein the one or more catalyst filled pressure vessel reactors is equipped with a control system capable of controlling the reactor system operating pressure.

30. The method of claim 21, wherein the one or more catalyst filled pressure vessel reactors is equipped with an internal or external heat transfer system to modify the temperature of the reactor as the reaction progresses.

31. The method of claim 21, wherein one or more of the catalyst filled pressure vessel reactors are designed as pipe-in-pipe heat exchangers.
